(19) United States
(12) Patent Application Publication
(10) Pub. No.: US 2021/0365918 A1
(43) Pub. Date: Nov. 25, 2021

(54) GLOBAL COMBINATION PAYMENT SYSTEM AND METHOD USING ISOLATED DATA STORAGE

(71) Applicant: Edward Showalter, Santa Monica, CA (US)

(72) Inventor: Edward Showalter, Santa Monica, CA (US)

(21) Appl. No.: 17/339,851

(22) Filed: Jun. 4, 2021

Related U.S. Application Data
(63) Continuation-in-part of application No. 16/824,489, filed on Mar. 19, 2020.
Application No. 16/824,489 is a continuation-in-part of application No. 16/824,507, filed on Mar. 19, 2020.
(60) Provisional application No. 62/821,349, filed on Mar. 20, 2019.
(60) Provisional application No. 62/821,353, filed on Mar. 20, 2019.

(51) Int. Cl. G06Q 20/22; G06Q 40/02; G06Q 40/04; G06Q 20/34; G06Q 20/32; G06Q 20/38; G06Q 20/12; G06Q 20/36; G05B 19/4155; G06F 21/62; G06F 16/9035

(52) U.S. Cl. CPC G06Q 20/227; G05B 2219/40269; G06Q 40/04; G06Q 20/3572; G06Q 20/326; G06Q 20/322; G06Q 20/389; G06Q 20/12; G06Q 20/367; G06Q 20/381; G06Q 20/387; G05B 19/4155; G06F 21/6218; G06F 16/9035; G06Q 40/025

(57) ABSTRACT

A global combination payment system for use in commerce by users, the global combination payment system comprising: a combination payment platform adapted to provide users with an interface through which the users may interact with other users, such that to engage in commerce, make payments, and exchange goods and services; and a combination payment vehicle for use as a payment method, the combination payment vehicle comprising a plurality of distinct and separate funding sources that may be selectively combined to make a purchase, the plurality of funding sources being selectable from cash, credit card, debit card, payday loan, cryptocurrency holdings, merchant digital loyalty rewards, investment stock and bond holdings; wherein a total value of the plurality of funding sources defines a line of credit via which to make a payment; and wherein the users each have a user account within the combination payment platform for engaging in commerce.

### CROSS-REFERENCE TO RELATED APPLICATIONS

This application is a continuation-in-part of and claims the benefit of U.S. Non-Provisional application Ser. No. 16/824,489, filed Mar. 19, 2020, which claimed the benefit of U.S. Provisional Application No. 62/821,349, filed Mar. 20, 2019, and is a continuation-in-part of and claims the benefit of U.S. Non-Provisional application Ser. No. 16/824,507, filed Mar. 19, 2020, which claimed the benefit of U.S. Provisional Application No. 62/821,353, filed Mar. 20, 2019, which are hereby incorporated by reference, to the extent that they are not conflicting with the present application.

### BACKGROUND OF INVENTION

### 1. Field of the Invention

The invention relates generally to commerce and e-commerce methods, and more specifically to a method of payment which can utilize both the liquid and non-liquid assets, including rewards and loyalty programs and/or points systems, of an individual to purchase goods or services.

### 2. Description of the Related Art

Over the last decade, the global economy has increasingly moved away from a reliance on cash obtained from traditional brick and mortar financial institutions, or even physical credit and debit cards, for purchasing goods, services, and the like. As an example, as the global population continues to rapidly grow more and more, Third World countries, as well First World countries like China, are seeing an emergence of more middle-class citizens who are gaining purchasing power to buy First World products, for example. Furthermore, the global emergence of the phenomenon of Cryptocurrency has enabled additional methods by which consumers may pay for goods, especially in Third World countries where many global citizens may not possess established bank accounts or credit cards, for example.

Another emerging market for payment systems is Fintech (“financial technology”), for example. Lenders, like AFFIRM®, for example, who grant instant loans online (and payable over a few months, for example) for consumers to use to purchase products from merchants, for example, has reshaped the marketplace, all while handling and processing the transaction in just a few nanoseconds. Yet another payment method that has gained immense popularity among consumers and merchants alike is the use of Wi-Fi-connected devices (e.g., cellphones, smart watches, etc.) to make purchases using digital payment systems, such as Apple Pay®, Venmo®, Square®, as well as Paypal®. Such mobile payments are moving the world's consumers toward a cashless economy.

As an example, many global economies are isolated, especially in regions in Africa and in Asia. Mobile-money services, such as those discussed above, have become increasingly popular over the past decade in Africa and the Middle East, and regions in Asia, for example. To illustrate, approximately one in ten adults across Africa—about 100 million people—use such payment services. As another example, hyperinflation and economic isolation have pushed the breakaway republic of Somaliland closer to a virtual milestone than most other countries in the world: a cashless economy. Originating in Kenya, Vodacom Group Ltd.'s service M-Pesa®, broadly considered the first major and most successful mobile-money technology platform, counts almost 42 million users, well over half the population of Kenya. Moreover, more than half of the world's 282 mobile-money platforms are located in sub-Saharan Africa, for example. Accordingly, the African continent, home to many of the world's frontier economies, has come closest to “leapfrogging” traditional brick and mortar banks and heavily adopting the use of mobile devices (e.g., smart phones, tablets, etc.) as digital wallets.

In the United States, many Americans, over 26 million, for example, live in poverty and do not have bank accounts. In many cases, these individuals have to go to a check cashing facility to cash their payroll checks. Furthermore, many more Americans are trapped in the seemingly endless cycle of pay day loans, not able to break away from that high cost of borrowing. Globally today, almost all working capital is provided by banks and financial institutions. As such, it can be difficult for small companies and individuals to obtain funding at rates that are typically only available to much bigger companies and/or individuals with high credit scores. As an example, alternatives to traditional credit-scoring methods can be explored, such as considering rent and mobile phone payments, consumer shopping behavior and social-media activity when evaluating a user's credit. Such an alternative may actually offer new and innovative ways to protect consumers and merchants, while allowing small companies and individuals to obtain funding.

Generally, many people who purchase goods or services from merchants, vendors, sellers, and other businesses may be a part of a rewards or loyalty program offered by each individual business, for example. These rewards programs may offer points or other similar rewards that may be accrued by a user, and the user may exchange the points for goods or services, for example, like a traditional payment method. Because many merchants and businesses may offer their own rewards or loyalty programs, a single consumer may be a part of, for example, 5-30 different rewards programs. It can become difficult for a user belonging to that many different rewards programs to manage and track their customer reward points across the various rewards and loyalty programs. Some users may lose track of their earned points, which could expire if unused, and thus go to waste. Some rewards programs may also offer other kinds of benefits instead of or in addition to points, and a user may not be aware of all benefits available to them or may be unable to track all of their available benefits.

Additionally, some goods or services that are available to a user via the rewards points may not be needed by the user, who instead may wish to be able to use their rewards points for another purpose. Some users may also sell their loyalty rewards such as frequent flyer miles and free or discounted hotel stays on the open market to other users. However, this can be a difficult and time-consuming process. Similarly, it may be difficult and costly for merchants to create, advertise, and maintain their rewards programs. Merchants offering rewards or loyalty programs may also have other problems, such as, for example, in the case of smaller businesses being unable to compete with larger businesses.

An example of a system wherein rewards are offered to customers is crowdfunding. Crowdfunding websites may allow for a customer or “backer” to donate or send money to a campaign (e.g., product launch), and receive a reward (e.g., a discount for said product) in return. However, such platforms may be unable to capture data or offer a reward to a backer who refers another backer to the campaign (i.e., a referral). Another problem is that rewards promised to backers could go unfulfilled, and it may be difficult for backers to resolve this issue. Another problem is that these platforms may not be capable of rewarding a backer who supports multiple campaigns for a particular length of time; thus, these backers cannot be rewarded for the support of multiple campaigns, for being a frequent backer, or for supporting campaigns for a predetermined amount of time.

Thus, there is a need to solve the problems above by providing a payment method which utilizes and combines a multitude of payment methods, including rewards and loyalty points, into a single global payment system.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a global combination payment system for use in commerce by users is provided. The global combination payment system may comprise: a combination payment platform configured to operate on a device, the combination payment platform being adapted to provide users with an interface through which the users may interact with other users, such that to engage in commerce, make payments, and exchange goods and services; and a combination payment vehicle for use as a payment method within the combination payment platform, the combination payment vehicle comprising a plurality of distinct and separate funding sources that may be selectively combined to make a purchase, the plurality of funding sources being selectable from cash, credit card, debit card, payday loan, cryptocurrency holdings, merchant digital loyalty rewards, and investment stock and bond holdings; wherein a total value of the plurality of funding sources defines a line of credit via which to make a payment; wherein the users each have a user account within the combination payment platform for engaging in commerce with other users; and wherein, when a first user makes a purchase from a second user via the combination payment platform, a cost of the purchase is deducted from the total value of the plurality of funding sources, such that each of a selected portion of the cost of the purchase is deducted from a value of each selected funding source of the plurality of funding sources, respectively.

In another aspect, a method of making a purchase using a global combination payment system, the global combination payment system comprising a combination payment platform configured to operate on a device is provided, the combination payment platform being adapted to provide users with an interface through which the users may interact with other users, and a combination payment vehicle for use as a payment method within the combination payment platform, the combination payment vehicle comprising a plurality of distinct and separate funding sources that may be selectively combined to make a purchase. The method may comprise the steps of: creating and/or logging into a user account within the combination payment platform via the device; selecting and linking a plurality of funding sources with the user account, such that to form the combination payment platform, a total value of the plurality of funding sources defining a line of credit via which to make a payment; selecting a merchant from whom to purchase goods and/or services from, the merchant being a user within the global combination payment system; selecting goods and/or services to purchase from the merchant, the selection of, and a total cost of, the goods and/or services being virtually collocated within a shopping cart of the combination payment platform; and purchasing the selected goods and/or services from the shopping cart, the total cost of the goods and/or services being deducted from the total value of the plurality of funding sources, such that each of a selected portion of the total cost of the purchase is deducted from a value of each selected funding source of the plurality of funding sources, respectively.

In another aspect, a method of facilitating a global combination payment system for use in commerce by users is provided. The method may comprise the steps of providing a combination payment platform configured to operate on a device and to provide users with an interface through which the users may interact with other users, the combination payment platform being programmed to: establish a relationship between a user and the combination payment platform via a user account, the user account providing the user with a central hub via which to selectively engage in commerce, make payments, exchange goods and services, and track shipments; digitally establish a connection with, and securely link, the user's account with a plurality of distinct and separate funding sources, such that to form a combination payment vehicle for use as a payment method within the combination payment platform, the plurality of funding sources being adapted to be selectively combined such that to make a purchase, and the plurality of funding sources being selectable from cash, credit card, debit card, payday loan, cryptocurrency holdings, merchant digital loyalty rewards, and investment stock and bond holdings; and digitally store user data into a memory storage device, the memory storage device being configured to be autonomously moved to an offline computer, such that to digitally transfer the user data into the offline computer for safe storage of the user data.

In another aspect, an isolated data storage system for the safe and secure storage of user data being transmitted within a network is provided. The isolated data storage system may comprise: a plurality of memory storage devices each being removably associated with at least one mainframe computer in communication with the network, each memory storage device being configured to digitally receive user data from the at least one mainframe computer; at least one robotic arm configured to autonomously move each memory storage device of the plurality of memory storage devices; at least one offline computer being adapted to receive the plurality of memory storage devices, such that the user data stored on each of the plurality of memory storage devices may be downloaded to the at least one offline computer; and a set of storage racks having a plurality of capsules, each capsule of the plurality of capsules being adapted to receive each of the plurality of memory storage devices, respectively, such that to securely store the plurality of memory storage devices; wherein, when user data is received by a memory storage device of the plurality of memory storage devices, one of the at least one robotic arm autonomously removes the memory storage device from the at least one mainframe computer and associates the memory storage device with one of the at least one offline computer, the user data being digitally transferred from the memory storage device into the offline computer, the one of the at least one robotic arm subsequently and autonomously moving the memory storage device from the one of the at least one offline computer to the set of storage racks, the memory storage device being placed into a capsule of the plurality of capsules.

In another aspect, a method of facilitating a universal rewards program for use in managing digital rewards received by users from a global e-commerce network is provided. The method may comprise the steps of providing a rewards management system configured to operate on a device and to provide users with an interface through which the users may interact with other users, the rewards management system being programmed to: establish a relationship between a user and the rewards management system via a user account, the user account being digitally linked to the global e-commerce network and providing the user with a central hub via which to selectively monitor, purchase, or sell the digital rewards; digitally establish a connection with, and securely link, the user's account with at least one depository account for use as a supplemental payment method, the at least one depository account being adapted to supply or receive funds; store the digital rewards and any additional digital rewards in a digital wallet associated with the user account; selectively convert digital rewards stored within the digital wallet into currency to be deposited into the at least one depository account, or exchange the digital rewards for other digital rewards stored within a second digital wallet belonging to a second user; and digitally store user data into a memory storage device, the memory storage device being configured to be autonomously moved to an offline computer, such that to digitally transfer the user data into the offline computer for safe storage of the user data.

Thus, an advantage is that the Combo Pay System may give a user the freedom to selectively combine a plurality of payment methods to make a single purchase. An additional advantage is that, because a user may make purchases for goods or services using a selective combination of a plurality of payment methods, the user may thus make a larger purchase that a single traditional payment method would not cover. Another advantage is that a user is not limited to solely purchasing goods or services from a select few merchants or vendors in the Combo Pay System, which may thus cater to the user's preferences. Another advantage is that user data may be securely collected, stored, and transmitted within the Combo Pay System, allowing consumers and merchants alike to confidently and safely conduct transactions using the Combo Pay System. An additional advantage is that the need for users to manage and track multiple rewards systems from multiple vendors may be diminished or eliminated. Another advantage is that a single rewards system may save time for users who need to manage only a single rewards system. Another advantage is that a user may earn capital from the selling of rewards points through the reward management system. Another advantage may be that the blockchain technology reduces the risk of users' data being stolen. Another advantage may be that the isolated data storage system may reduce or eliminate the risk of users' data being stolen.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-1D illustrate a chart detailing exemplary execution method of a Combo Payment System, which can be used globally and in real time, according to an aspect.

FIGS. 2A-2D illustrate exemplary blockchain amalgamation of the disclosed Combo Pay system, according to an aspect.

FIGS. 3A-3C illustrate examples of a diagrammatic view of a universal system for managing rewards, used with a crowdfunding campaign, according to an aspect.

FIGS. 4A-4B illustrate examples of a diagrammatic view of isolated data storage working with autonomous robotic offline data storage, according to an aspect.

FIGS. 5A-5C illustrate examples of a diagrammatic view of a blockchain network using blockchains in a juxtaposed formation and an amalgamated formation, according to an aspect.

FIG. 6 illustrates an example of a diagrammatic view of secured isolated data storage system working with an autonomous robotic arm, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a mobile network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

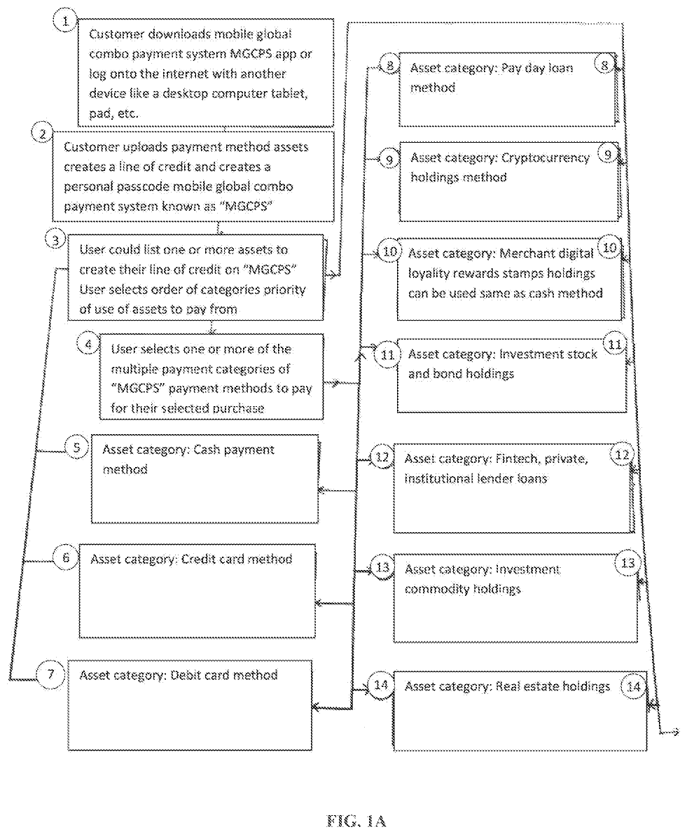

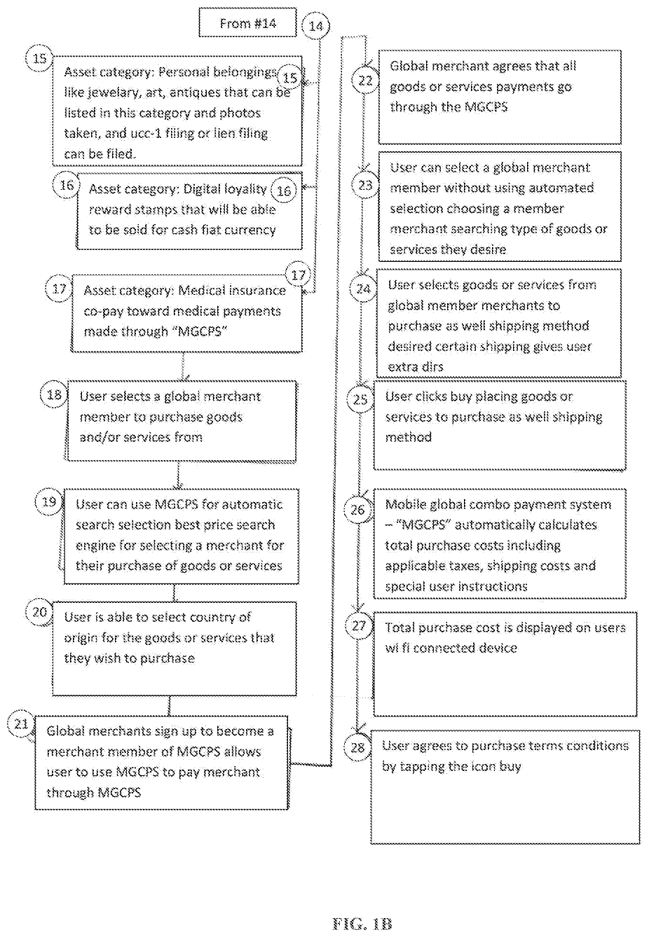

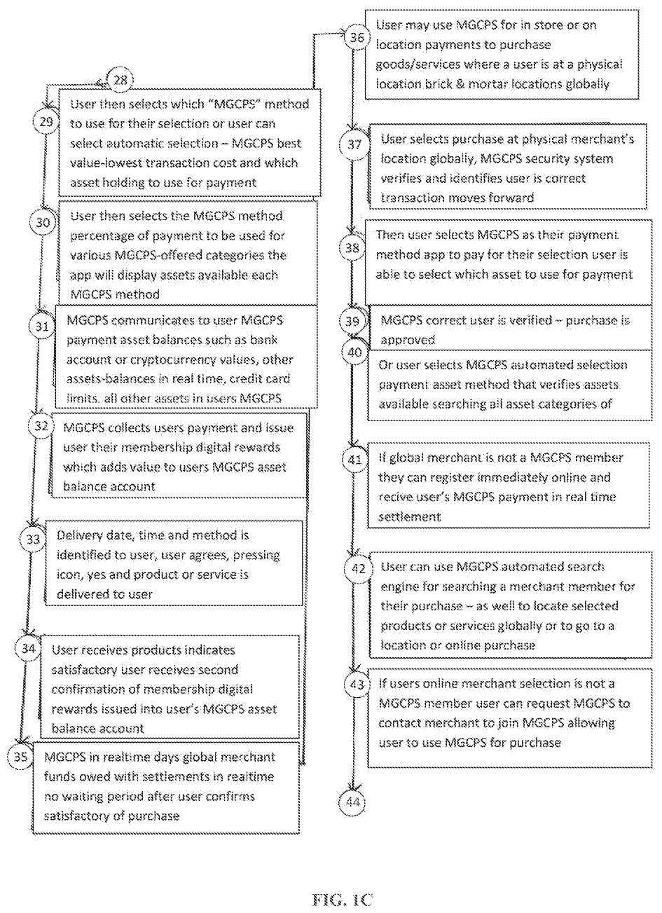

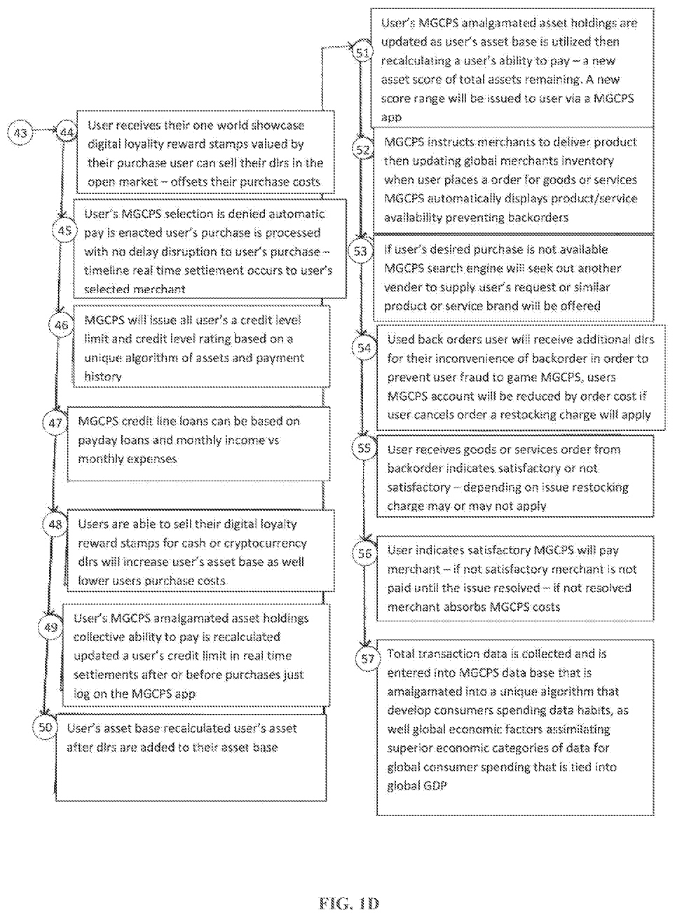

FIGS. 1A-1D illustrate a chart detailing exemplary execution method of a Combo Payment System, which can be used globally and in real time, according to an aspect. As an example, users of a Combo Pay System (“Combo Pay System,” “Combo Payment System,” “Combination Payment System,” “Global Mobile Combo Payment System,” “GMCPS”) may fall into two categories: (1) merchants (“merchant,” “merchant member,” “member merchant”) or (2) consumers. A merchant may be the owner or leaser of a brick-and-mortar store or online store who buys and sells goods or services, for example. A consumer may be a user who purchases merchandise or services sold or provided by merchant users at their brick and mortar or online stores, for example, respectively.

As an example, a Combo Payment platform (“Combo Pay platform,” “Combination Payment platform,” “platform”) may be an interface through which users may utilize all functions of a Combo Pay System. An exemplary Combo Pay platform may be a website through which a user may access the functions and services of the Combo Pay System. The Combo Pay platform website may also have or alternatively be an associated Combo Pay platform application (“Combo Pay platform application,” “Combo Pay app”), such as a mobile application for cell phones and tablets or a desktop application for computers, for example. Additionally, as an example, the Combo Pay platform may be provided as a payment card (e.g., a unique credit card) (“Combo Pay System Credit Card”) through which users may easily make payments, especially in person, for example. As an example, the Combo Pay platform may be developed and operate in software and/or hardware comprising logic operations for carrying out the particular functions of the Combo Pay System. The particular functions and services of the Combo Pay System, and its interactions with the Combo Payment platform, will become evident throughout the description hereinafter.

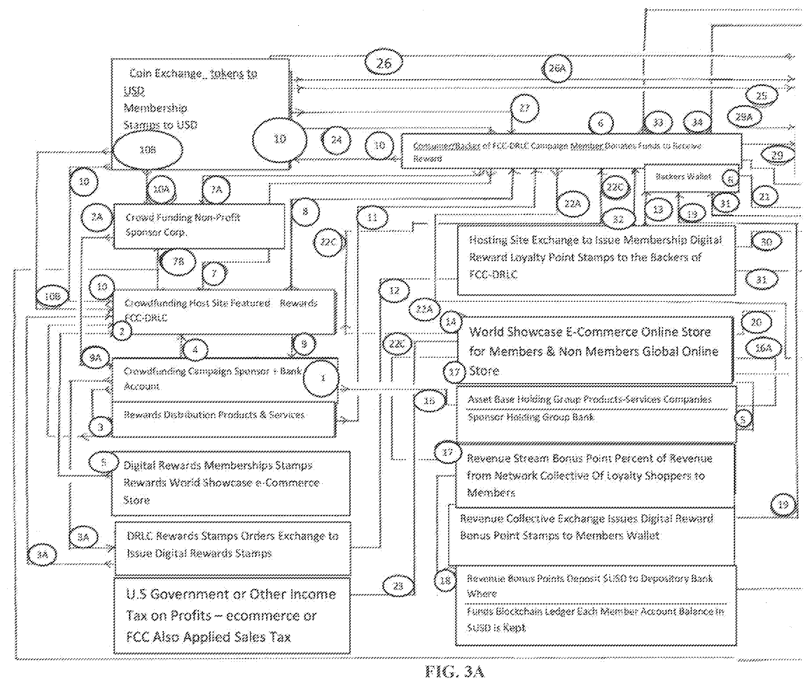

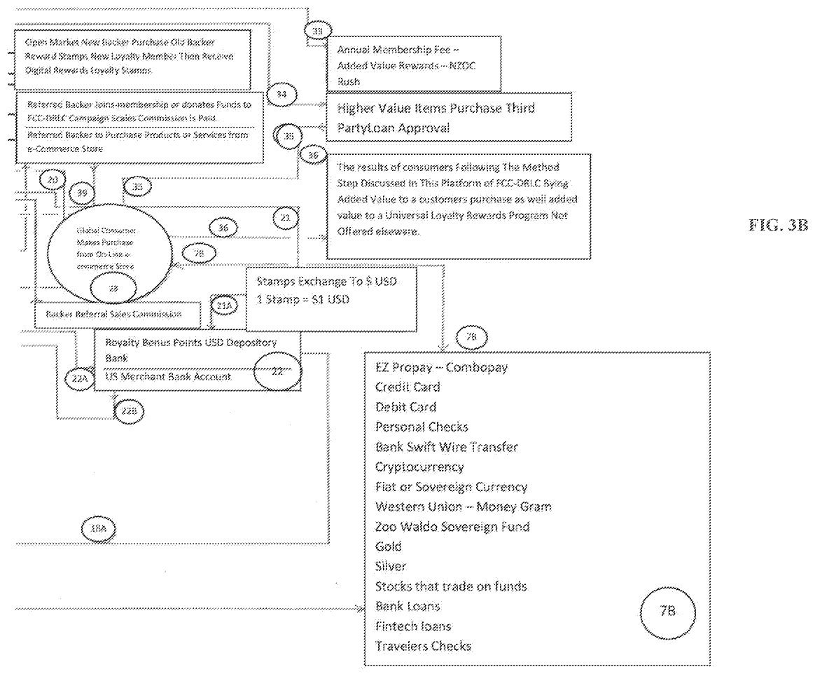

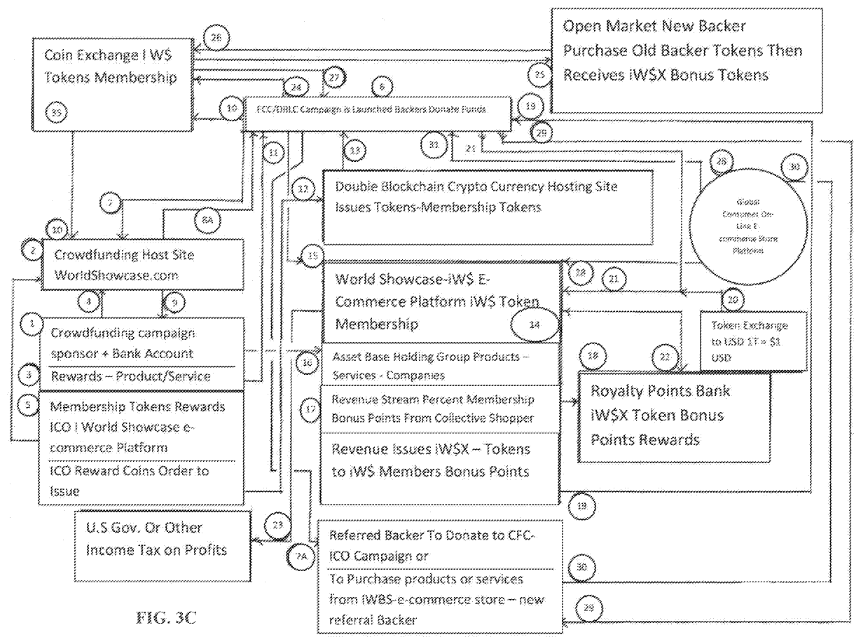

As an example, the Combo Pay System may be a worldwide/global payment method facilitated by a method which allows users (e.g., consumers) to combine their different payment and financial assets into one amalgamated payment method, thus allowing a user to access and utilize their collective ability to pay. Users may use a Combo Pay System Credit Card or a Wi-Fi-connected device, such as a mobile phone, tablet, laptop, desktop computer, etc., for example, to make payments, as mentioned above. This feature may allow consumers and merchants globally to use a single payment system that utilizes a combination of their assets (both liquid and non-liquid) to make and/or receive payment, wherein a user can preset asset combinations to make different Combo Payment Methods (“Combo Payment Methods,” “Combo Payment Vehicle,” “Payment Asset Method,”), as will be disclosed in greater detail hereinafter. Users may also be provided with Digital Membership Loyalty Rewards (“Membership Digital Rewards,” “Digital Loyalty Reward,” “World Showcase Digital Loyalty Reward Stamps,” “Digital Loyalty Reward Stamps,” “DLRS”), which could be redeemed by a user. A user could use the Digital Loyalty Rewards as cash to make purchases or a user could sell the Digital Loyalty Rewards to other users for cash, an example of which will be described in greater detail when referring to FIGS. 3A-3C below.

As an example, the Combo Pay System may allow farmers or other merchants to purchase seeds, feed for farm animals, tools and equipment, and/or other inventory for their businesses. The Combo Pay System may allow merchants or consumers to receive instant short-term loans to purchase inventory or goods, respectively, which can be automatically paid off (e.g., small portions of the loan being deducted with each sale) as the merchant sells said goods. As an example, the short-term loans can come from Financial Technology (“Fintech”) lenders, institutional lenders, personal lenders, or Payday lenders, as will be disclosed in greater detail hereinafter.

What follows is an exemplary method of executing/creating a global Combo Pay System, which is illustrated by the flowchart shown in FIGS. 1A-1D, for example.

As shown in FIG. 1A, a user first goes to the Combo Pay platform website or downloads the COMBO PAY platform app to their Wi-Fi connected device (step 1), such as a smartphone, tablet, etc., and creates or signs into a Combo Pay System account (“Combo Pay System account,” “Combo Pay account,” “account”). Next, a user will create a line of credit by uploading/synchronizing the different payment methods they wish to use with their Combo Pay account and create personal passcode identifiers (for security purposes) (step 2). It should be noted that a user can upload payment assets from one or more payment categories, and that the user can set an order of priority as to which uploaded payment method is used first (step 3). In other words, once a user uploads the payment types they wish to use on their account, the user can select which payment type is used first. For example, if a user makes a purchase for $50 dollars, then the $50 will be taken from the first priority asset, and if the first priority asset has insufficient funds, then the $50 will be taken from the second priority asset. It should be understood that a user may upload multiple payment assets within each category, and the order of priority is set to the specific payment asset rather than a payment category. It should also be understood that a total of the payment assets a user uploads will determine the credit limit for the user's line of credit.

As shown, to upload a payment asset, a user first selects a payment category (step 4) from a list of payment categories. Exemplary payment categories (steps 5-14) of the Combo Pay System are: (step 5) cash, such as, for example, fiat currency, U.S. dollars, CASH Vehicle Methods, hard sovereign currency, bank checks, bank debit cards, travelers checks, Western Union, bank wire transfer, or money grams; (step 6) credit cards, such as, for example, VISA® credit card, MASTERCARD® creditcard, Discover Card® credit card, or American Express® credit card; (step 7) debit cards; (step 9) Cryptocurrency, such as, for example Bitcoin, Ether, Block. One, Telegram, File coin, or any cryptocurrency whose coin base is trading; (step 10) Customer Loyalty Rewards which can be used same as cash, such as, for example, World Showcase—World Membership Stamps (WMS), World Showcase—World Xtra Stamps (WXS), airline frequent flyer mile rewards, hotel rewards, restaurant rewards, or any merchant rewards that have a hard currency value and can be traded for U.S. dollars, or a foreign currency; (step 11) stocks and bonds, i.e., stocks that are traded on NASDAQ, NYSE, Hong Kong Exchange, or any foreign stock where stocks in publicly traded companies can be traded for U.S. dollars, such as Apple®, Microsoft®, Amazon®, ABINBEV, or any stocks that could be used as collateral for an instant loan to complete a user' s purchase; (step 12) fintech lenders, institutional lenders, or personal lenders, such as, for example, AFFIRM®, Prosper®, LendingClub®, Wells Fargo® Bank, Chase® Bank, regional and local banks, credit unions, or any licensed bank; (step 13) commodities, such as, for example, gold, silver, oil, sugar, soybean, or any other commodity that could be leveraged as collateral for an instant loan to complete a user's purchase; (step 14) real estate holdings, such as, for example, personal home, commercial real estate, income property, or any real estate that could be leveraged as collateral for an instant loan to complete a user's purchase; (step 15) personal belongings, such as jewelry, art, antiques, and so on; (step 16) digital merchant loyalty reward stamps, which can be sold for cash fiat currency; (step 17) medical co-pay insurance, i.e., if a user has medical co-pay of $10.00 for a prescription, then the user could use a payment method such as a credit card to pay the $10.00 co-pay portion and the medical co-pay insurance to cover the rest of the prescription purchase; and (step 8) pay day loans, i.e., a user could receive advanced funds from a payday lender for a purchase, wherein the payday loan is repaid on a user's payday when the user's paycheck is direct deposited into one of the Combo Pay System member banks or wherein the payday loan is repaid when a user presents valid identification and employment verification to deposit a paycheck into a user's bank account at a Combo Pay System member bank.

As shown in FIG. 1B and continuing the example above, when a user (i.e., consumer or merchant) wishes to make an online purchase using the e-commerce portion of the Combo Pay Platform, the user must first select a merchant member on the platform to purchase from (step 18). If the user does not have a particular merchant member in mind, then the user can search the e-commerce portion of the Combo Pay Platform for the goods or services they wish to purchase. Then, the Combo Pay Platform will automatically select a merchant member, based on proximity to the user, even if the user is in a foreign country (step 19). Alternatively, the Combo Pay Platform may suggest a list of member merchants and the user can then choose a member merchant from the list (step 23). To filter the search result, a user can select a country of origin for the goods or services (step 20). For example, a user can filter for goods made in America, Italy, China, etc.

If the user selects a merchant who is not a member of the Combo Pay System or if a merchant would simply like to become a member of the Combo Pay System, then the merchant can sign up to become a merchant member, thus allowing the user to pay for the goods or services purchased from the merchant though the Combo Pay System (step 21). After the user purchases goods from another merchant member (or from an external merchant or vendor), then the user can post their merchandise, such as goods or services, for sale on the Combo Pay Platform. For example, the user may be a farmer who purchases soybean seeds from a merchant member. Then, the farmer could post their soybeans on the Combo Pay Platform once they are grown and ready to sell. As shown, for a merchant to become a member and sell goods or services though the Combo Pay System, the merchant must agree that all payments the merchant member receives for sold merchandise will go through the Combo Payment System (step 22). Additionally, a merchant member must apply and agree to the terms and conditions of the Combo Pay System. To post goods or services for sale on the Combo Pay Platform, the merchant member is to list their items for sale by setting pricing, shipping terms, return policy, etc. Alternatively, a merchant member can provide a link to their own online website, which can be linked to the Combo Pay Platform, or simply use the Combo Pay System to process sales of goods or services that are listed for sale, for example. As an example, when a consumer makes a purchase from the merchant member, the total price of the purchase may be released/deposited into the merchant member's account (e.g., a bank/deposit account) or into the merchant member's own Combo Pay vehicle (i.e., received sales funds broken up and deposited into appropriately corresponding asset categories, depending on the payment method chosen by the consumer, for example).

Once a user selects an online e-commerce merchant member form the Combo Pay Platform, the user is ready to go shopping and select items they wish to purchase from the merchant member. As shown in FIG. 1B, a user will select an item to purchase, then select a shipping method offered by the Merchant Member the user is purchasing from (step 24). To buy the items, a user can place the items in the Combo Pay Platform shopping cart and click “buy” (i.e., digital purchase button) (step 25). Once the user clicks “buy,” the Combo Pay Platform will automatically calculate the purchase price total and add any applicable government tax (e.g., sales tax) to the total purchase (step 26). The total cost to the user will then be displayed (via touchscreen or display screen) on the user's Wi-Fi-connected device being used to purchase the online items (step 27). To finalize the purchase, the user will be prompted to agree to the total purchase price by once again clicking a “buy” button displayed on their Wi-Fi-connected device (step 28), for example.

As shown in FIG. 1C, after a user agrees to the total purchase price by clicking “buy,” the user will be presented with a screen (e.g., displayed on the user's device) to select which payment method they wish to use (step 29). On the payment method selection screen, the user can select an “automatic best value” (“automatic best value,” “automatic payment,” “Automatic Pay”) option, wherein the Combo Pay System will select which payment method(s) to use for the best value (based on available assets or credit, for example), or the user can manually choose any combination of payment methods to complete their purchase. For example, the user can select a percentage they wish to be deducted from each payment method to make the purchase (a total of the percentage equaling a total of the purchase cost), such as 50% (“fifty percent”) of the cost from Visa® credit card, 25% (“twenty-five percent”) of the cost from a bank debit card, and 25% (“twenty-five percent”) of the cost from a cashing of merchant loyalty rewards (step 30). In doing this, a Combo Pay System user would select exactly which Visa® credit card account they wish to use, exactly which brand of bank debit card account they wish to use, and exactly which merchant loyalty rewards they wish to cash in and use, for example. Thus, an advantage is that the Combo Pay System may give a user the freedom to selectively combine a plurality of payment methods to make a single purchase. An additional advantage is that, because a user may make purchases for goods or services using a selective combination of a plurality of payment methods, the user may thus make a larger purchase that a single traditional payment method would not cover.

As shown, after the user selects which payment methods to use, the Combo Pay System and Platform may communicate to a user how much asset payment value a user has in each of the payment categories, and in each specific payment vehicle (i.e., specific bank debit cards, specific loyalty rewards, etc.), such that the user knows how many funds are available for use as a Combo Pay Method (step 31). For example: A user's Visa® credit card (#1) has $3,257 available credit to be used and a second Visa® credit card (#2) only has $212 available credit to be used as payment for a purchase. If the total amount the user wishes to purchase is $510, for example, then the Combo Pay System would select Visa® credit card #1 to pay for the purchase. This method of selection of a Combo Payment Vehicle applies to all the user's Combo Pay System categories, for example.

As shown in FIG. 1C, when the Combo Pay System finalizes the purchase, the System will collect the funds from the user and issue the user their Digital Loyalty Rewards (if applicable) (step 32). Next, the Combo Pay Platform will ask a user to confirm the delivery date, approximate time, and method of delivery, and will subsequently notify the merchant member to ship the products, as well as indicate the shipping method (step 33), which could be, for example, same-day delivery, next-day delivery, two-day delivery, two-hour delivery, ground delivery, air delivery, drone delivery, robot delivery, etc. Once a user receives the purchased goods (or services), and if the user indicates that the received products are satisfactory (step 34), then the Combo Pay System will send the merchant the funds (step 35) collected from the user in step 32, for example. It should be understood that, as soon as the transaction clears, it will be posted into the merchant's account within the Combo Pay System.

As shown, a user can also use the Combo Pay System at a merchant member's physical location (step 36), such as, for example, a retail store, restaurant, hotel or airline ticket counter, automotive dealership, movie theater, doctor's office, drug store pharmacy, grocery store, or gas station, or any retailer or service provider or membership club, such as a golf club or tennis club, or fitness club (e.g., a gym). As shown in FIG. 1C, first, a user selects their purchase at a physical merchant member's location, then the user's identity is verified by the Combo Pay Platform's security system (step 37). To make the purchase using the Combo Pay System, the user selects a preset Combo Payment Method (“Payment Asset Method”) (step 40) or manually chooses a combination of assets (step 38) to complete the payment, as disclosed previously above when referring to step 30. Alternatively, the user may use their Combo Pay Credit Card to pay for the purchase (as in traditional payment cards, for example). Next, the identity of the user is verified a second time, visually by the member merchant, for example, and the purchase is approved (step 39). The Combo Pay System may use several personal identifiers for identification verification, such as user's fingerprint, voice recognition, facial recognition, password code or number, birthday, etc., for example. The above-described feature would allow a user to use the Combo Pay System without using their Wi-Fi-connected device, such that the user may shop in-person as is traditionally done. Thus, an advantage is that a user may purchase goods or services in-person through the Combo Pay System, allowing the user to use a combination of all their liquid and non-liquid assets for making purchases in-person.

If the merchant at the physical location is not a member of the Combo Payment System, then the merchant can register online immediately to be able to receive payments from Combo Pay System users (step 41), as shown, for example. Alternatively, if the non-member merchant does not want to register, the user can use the search engine on the Combo Pay Platform to find an alternate online or in-person member merchant offering the goods or services the user is interested in purchasing (step 42). In the event the user is unable to find an online or physical member merchant to make a purchase from, for example, or if the user does not wish to purchase from any of the member merchants suggested by the Combo Pay Platform, then the user can select another non-member merchant and request that the Combo Pay System contact the non-member merchant to offer the non-member merchant to join the Combo Pay System (step 43). Thus, as outlined above, the user may be allowed to purchase from their selected merchant using the Combo Pay System. Thus, an advantage is that a user is not limited to solely purchasing goods or services from a select few merchants or vendors in the Combo Pay System, which may thus cater to the user's preferences.

Again, after a user makes a purchase, the user will receive their digital loyalty rewards based on the value (i.e., total cost/price) of the purchase made. Then, the user could sell their digital loyalty rewards on the open market to offset the cost of their purchase (step 44), as shown in FIG. 1D. Selling digital loyalty rewards for cash or cryptocurrency will also increase a user's asset base and thus lower a user's purchase costs (step 48). The digital loyalty rewards feature of the Combo Pay System will be described in more detail when referring to FIGS. 3A-3C.

As an example, if a user's Combo Pay Method is denied (i.e., one or more of the assets selected for the Combo Pay Method have insufficient funds), then Automatic Pay is enacted, and the purchase is processed with no delay or disruption to the user (step 45), as shown. As mentioned previously above, Automatic Pay is a feature of the Combo Pay System that enables the system to determine and select a funding or asset category from which to deduct the funds for the purchase. For example, Automatic Pay may be further adapted, such as in this case, to issue a short-term loan to a user if they are found to have insufficient funds. The short-term loan can be issued according to the user's credit limit, and the loan could be issued by a fintech lender or payday lender, for example. It should be understood that each user is issued a credit limit and credit level rating by the Combo Pay system based on a unique algorithm, wherein the algorithm analyzes the user's assets and payment history (step 46). It should also be understood that short-term credit line loans can also be based on payday loans, wherein the payday loans are based on a user's monthly income and expenses (step 47). Thus, an advantage is that a user's payment transaction may never be declined using the Combo Pay System, allowing the user to make purchases as desired without worry.

As an alternative example, each user will have a purchase payment credit level limit, in relationship with their digital loyalty rewards (“World Showcase-World Membership Stamps,” “WMS,” “World Xtra Stamps,” “WXS”) or their credit score and social media activity and followers/subscribers, as well as credit availability from Fintech lenders who are Combo Pay System members, such as, for example, AFFIRM®, Prosper®, LendingClub®, PeerLend®, etc. This approach would assist a user in completing their purchase without embarrassment of a denied credit card or debit card. As another alternative example, the Combo Pay System credit limit could be based on a user' s weekly or monthly payday income, where the Combo Pay System would be able to issue payday loans by making funds available to a user at a Western Union® location worldwide, for example, or a local bank. As users make purchases, their asset holdings and credit limit are recalculated by the Combo Pay System and updated to the Combo Pay Platform in real time (step 49) via a blockchain, as is known to those of ordinary skill in the art. A user's asset base is also recalculated and updated after the digital loyalty rewards are added to their asset base (step 50). As shown in FIG. 1D, as a user's asset base is recalculated and updated, a user is issued a new credit level rating (“asset score”) based on the user's updated asset base (step 51), as an example.

As shown in FIG. 1D, when the Combo Pay System instructs member merchants to deliver products to consumers, the Combo Pay System will automatically update a member merchants' inventory for goods or services and will display the updated inventory on the Combo Pay System (step 52). The automatic updating of the member merchants' inventory may thus reduce the likelihood a user's purchase will be placed on back order, for example. In the event a user's purchase is back-ordered (i.e., the goods or services are not currently available from the user's selected member merchant), then the Combo Pay System will select another merchant member (“vendor”) to provide the user with same or similar goods or services (step 53). Additionally, a user will receive additional (i.e., more than typically awarded) digital loyalty rewards to compensate a user for the inconvenience a back-order causes (step 54), for example. It should be noted that, to prevent fraud, the Combo Pay System can reduce a user's (i.e., merchant member's) account by the back-order cost and charge a restocking fee if a user (i.e., a consumer) cancels their order. When a user receives their purchased goods or services and indicates the goods or services are satisfactory, the Combo Pay System may or may not charge a restocking fee (step 55). Additionally, a member merchant will only receive a user's payment from the Combo Pay System once the back-order issue has been resolved (step 56), as shown. If the issue does not get resolved, a member merchant will have to absorb the cost, for example.

Thus, it should be understood that, as each purchase is completed, the total transaction data will be collected and entered into the Combo Pay System Database, where said data will be sent through a blockchain and amalgamated by a unique algorithm. Additionally, the algorithm may develop and analyze a user's spending habits, global economic factors, and global consumer spending, which are tied to the global GDP (step 57), as shown in FIG. 1D.

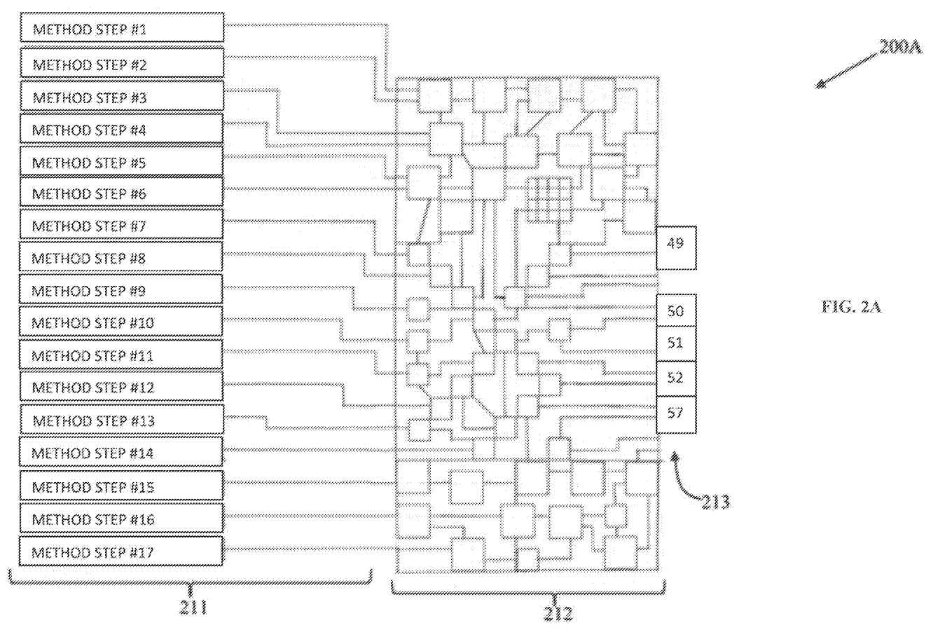

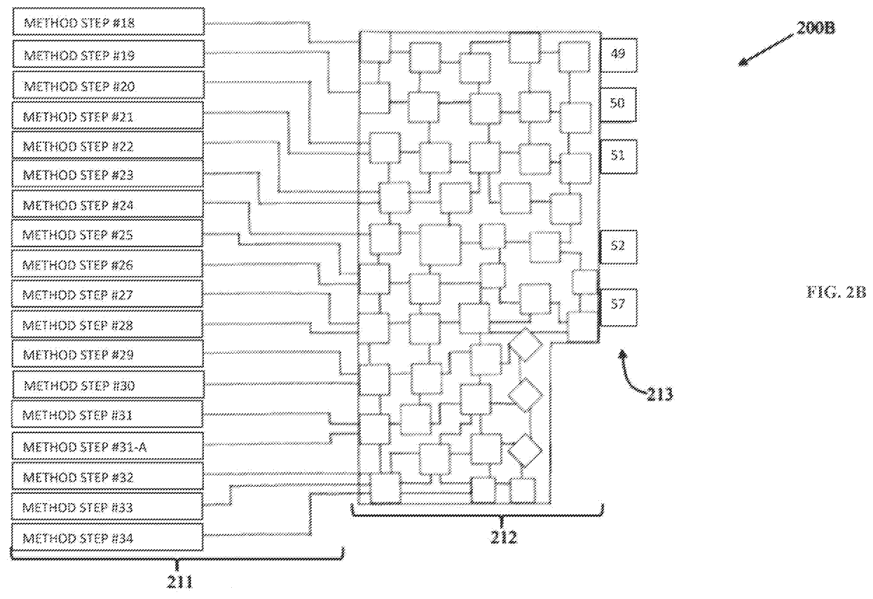

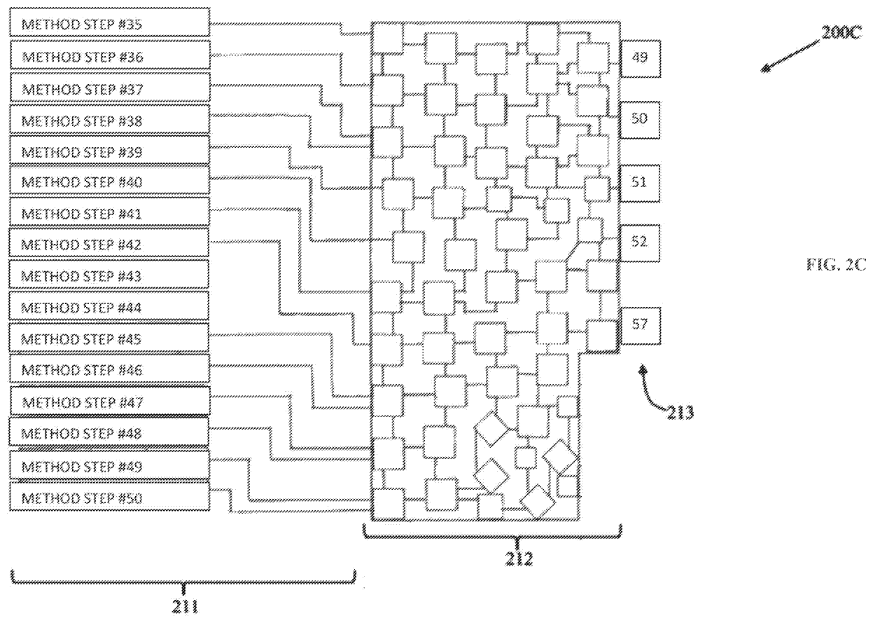

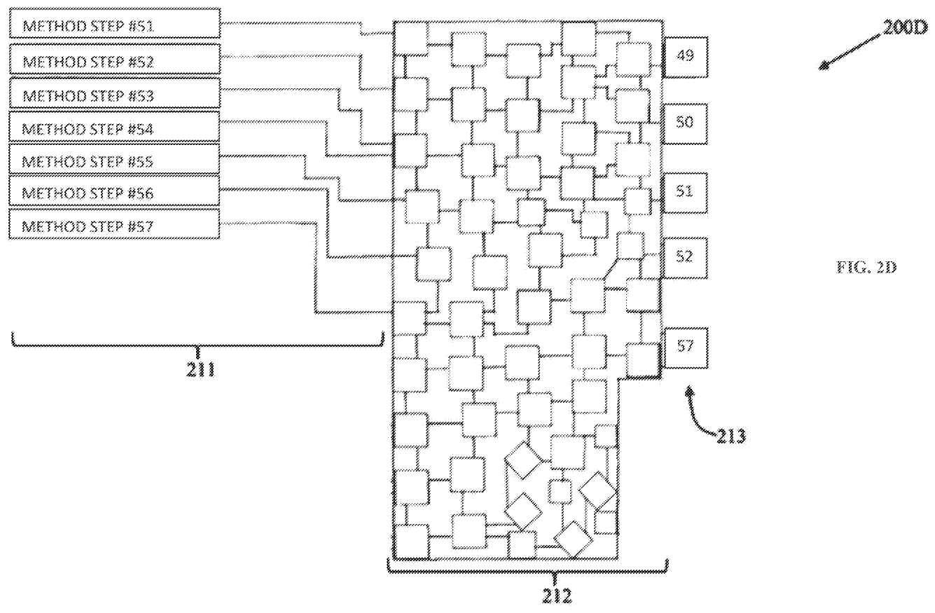

FIGS. 2A-2D illustrate an exemplary blockchain amalgamation of the Combo Pay System, according to an aspect. As mentioned hereinbefore, data collected (e.g., user data) by the Combo Pay System is sent through a blockchain to be amalgamated and secured. As will be described in detail below, FIGS. 2A-2D show an exemplary blockchain analysis, wherein the data collected by the Combo Pay System during steps 1-57, as disclosed above when referring to the flowchart of FIGS. 1A-1D, is input (“input data”) 211 into the block chain 211 and the blockchain outputs (“output data”) secured data. As shown by FIGS. 2A-2D, the output data 213 is the data disclosed when referring to steps 49, 50, 51, 52, and 57, respectively, of the flowchart of FIGS. 1A-1D. As is known in the art, a blockchain, being a continuously growing list of records referred to as blocks, may be linked and secured using cryptography, wherein each block may typically contain a data structure known as a hash pointer used for linking to a group of information (such as a timestamp and transaction data).

As an example, data collected from users when they register to use the Combo Pay System, upload payment assets, purchase goods or services through the Combo Pay System, and/or sell goods through the Combo Pay System, is input (at 211) into a blockchain 212. Next, as shown in FIGS. 2A-2D, the blockchain 212 analyzes the input data 211 and outputs amalgamated, secured data 213. More specifically, the output data 213 can be secured such that the output data 213 does not contain personal information of users or information regarding which user the data came from, for example. As an example, the output data 213 may be presented to users via the Combo Pay Platform. As another example, the secured output data 213 can be presented to member merchants, so the member merchants can view and independently analyze Combo Pay System user spending habits and trends. Thus, using user trend data, member merchants can optimize their online and/or brink and mortar stores to attract as many consumers as possible by tailoring their offered goods and/or services to particular user tastes. Thus, an advantage is that user data may be securely collected, stored, and transmitted within the Combo Pay System, allowing consumers and merchants alike to confidently and safely conduct transactions using the Combo Pay System.

As described previously throughout this disclosure above, the Combo Pay System may utilize digital loyalty rewards, both as a selectable payment method (e.g., by cashing in saved rewards points) and as a reward for conducting transactions using the Combo Pay System. In another aspect of the current invention, the Combo Pay System may be provided with a universal system for managing rewards, that is, rewards points accumulated across various user accounts with multiple merchants and vendors, for example. As will be described throughout this disclosure below, the universal system for managing rewards may not only allow users using the Combo Pay System to utilize accumulated rewards as currency (as described previously above) but may also to barter and trade certain rewards among the plurality of the Combo Pay System's users, as an example.

FIGS. 3A-3C illustrate examples of a diagrammatic view of a universal system for managing rewards, used with a crowdfunding campaign, according to an aspect. As an example, the universal system for managing rewards (“system for managing customer rewards,” “global reward management system,” “universal rewards management system,” “rewards management system,” or “rewards system”) may be used for managing a universal rewards program in which various merchants may participate, such as those in the Combo Pay System described herein above, such that merchants and patrons of the merchants alike may engage in a single marketplace using a single rewards program having a single, universal points currency. As mentioned previously in the Background above, currently, rewards points and stamps earned by a consumer (from retailers, restaurants, coffee shops, airlines, etc.) are unique to each merchant/business/seller, such that the consumer can only use and/or redeem such rewards points and stamps at those specific businesses, as an example. As will be described throughout this disclosure below, the universal rewards management system shall thus enable merchants/businesses/sellers belonging to a single e-commerce network (e.g., the Combo Pay System) to engage in commerce with consumers, such that the digital rewards and stamps earned by the consumers may thus be a single, universal rewards currency usable and redeemable with all members (consumers and merchants alike) within the e-commerce network.

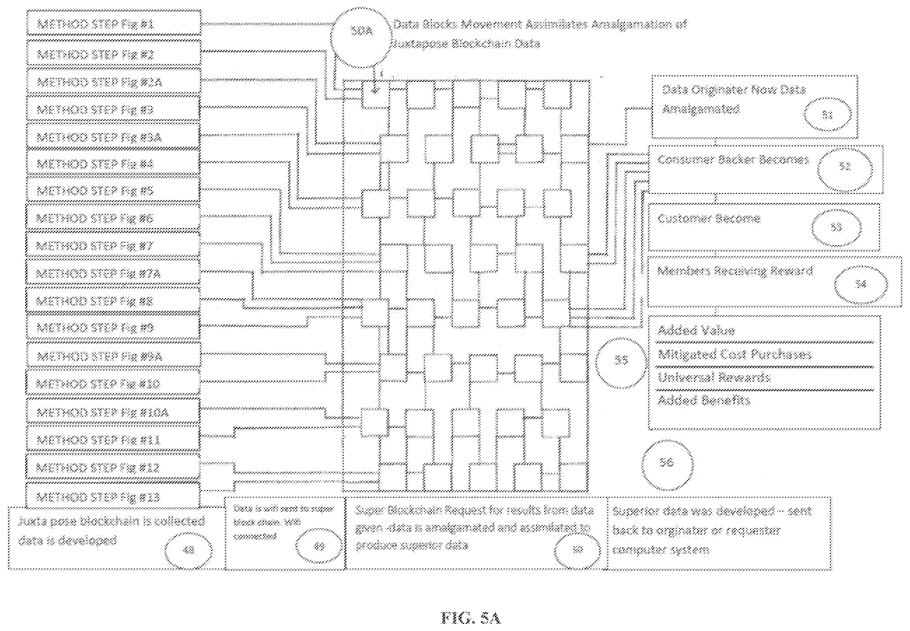

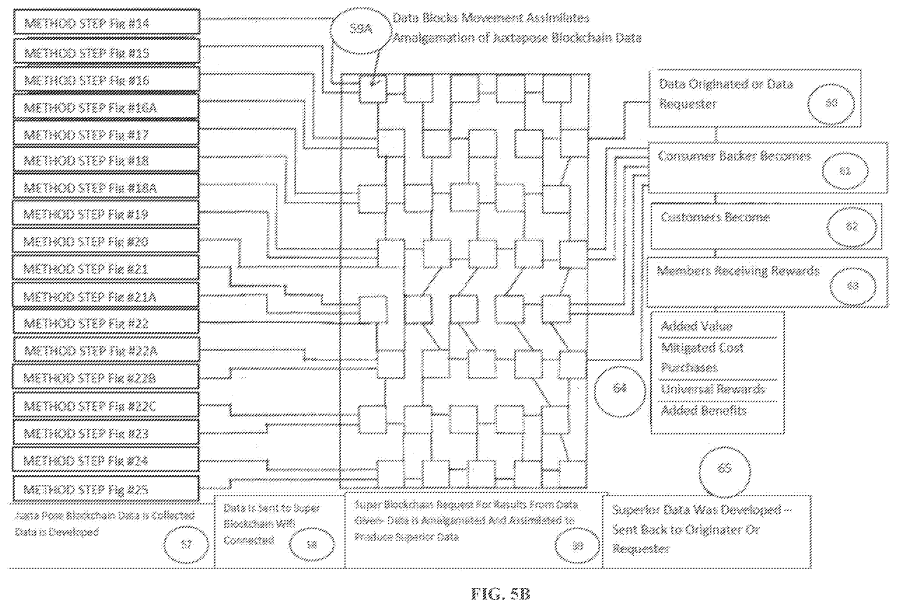

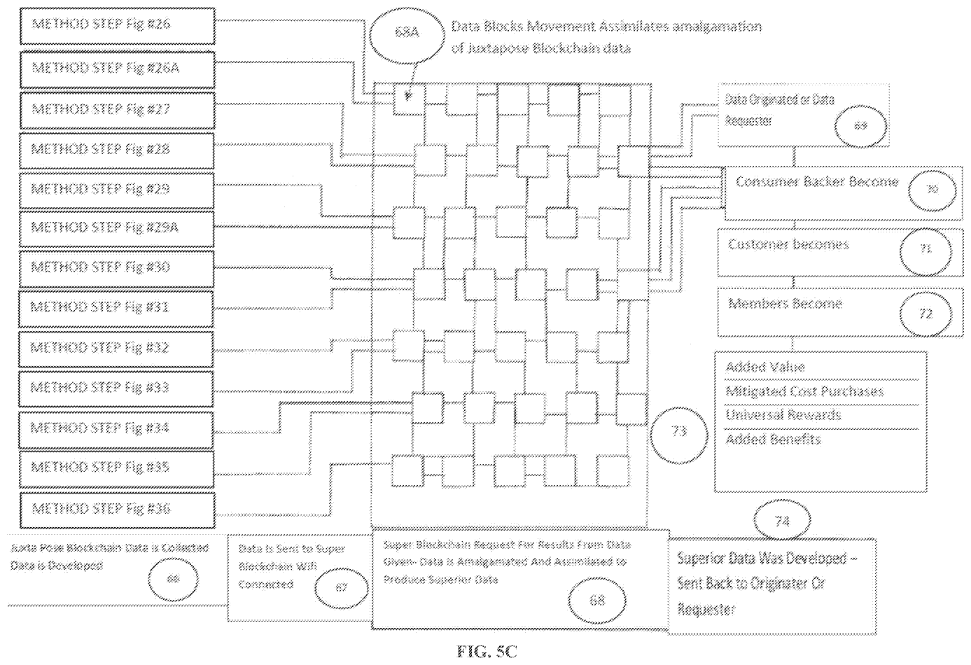

As another example, the reward management system may be used with crowdfunding campaigns (e.g., for product or service launches) within the e-commerce network. The reward management system may make use of blockchain technology, for example, as will be described in more detail when referring to FIGS. 5A-5C below. As an example, the reward management system may use multiple blockchains advancing data into a unique blockchain. Blockchain technology may be used for the reward management system and may be used for the purchase of products, services, or memberships, as described previously when referring to FIGS. 2A-2D above, within the Combo Pay System that utilizes the reward management system. As an example, the reward management system may use a single currency or points system, which may be referred to as digital stamps. Bonus points may also be earned through the reward management system and may be referred to as bonus point digital stamps.

As shown as an example in FIG. 3A, wherein arrows represent flows of information, a crowdfunding campaign operating within the Combo Pay System (or some other global e-commerce network, for example) may utilize the reward management system, and a crowdfunding campaign may be referred to as a “featured crowdfunding campaign” (FCC) by a sponsor of the campaign and may have an established bank account for receiving funds, for example (as shown by 1). The sponsor may have the capability to select from a number of host sites for their featured crowdfunding campaign. The sponsor may advertise the campaign by, for example, creating a white paper (e.g., a report or guide), and the information about the campaign may be distributed on the host site (shown by 4).

As shown for this example, the sponsor may also have the capability to offer rewards (e.g., digital loyalty rewards) to supporters (which may be referred to as “backers”) of the campaign via the reward management system (shown by 2). The sponsor may also have the capability to offer rewards to a backer who supports multiple campaigns, for example. As an example, the crowdfunding host site may be a non-profit and may thus be hosted by a non-profit sponsor corporation or company (shown by 2A). A backer may donate funds to a featured crowdfunding campaign, or a loyalty campaign (“loyalty campaign” or “digital rewards loyalty campaign”) sponsored by the host site. The sponsor may then distribute rewards, which may be products or services, to the backers (shown by 3). Rewards may be in the form of digital stamps (shown by 3A), as an example. Thus, an advantage is that a sponsor may no longer need to ship a physical product as a reward to a backer, allowing backers to instead choose and redeem their own products using the rewards. Backers may also have the opportunity for a membership to the reward management system (shown by 5), which may be separate from membership to the Combo Pay System, for example. Rewards may also be goods or services offered through the Combo Pay System (or other e-commerce network), for example. Thus, a backer, who may also be a “member,” may donate funds to a campaign or multiple campaigns to receive rewards (shown by 6).

As shown in FIG. 3A, the funding by a backer may be via the host site (shown by 7). Again, as an example, the campaign could also be a non-profit campaign (shown by 7A). The backer may also access the campaign via a mobile application (shown by 8) (e.g., the Combo Pay app), which may allow access to a digital wallet. The hosting site (which may be a non-profit hosting site, shown by 9A) may send funds from the backer to the sponsor's established bank account (shown by 9). The backer may use a cryptocurrency as donated funds (shown by 10) to the campaign, or to a non-profit (shown by 10A). Again, as previously discussed, rewards, which may be products or services offered through the Combo Pay System, may be distributed to the backer (shown by 11). The sponsor may carry this out by issuing an order via the reward management system, and thus place an order through a blockchain marketplace (which may be a “blockchain stamp marketplace”) in order to issue membership digital stamps to backers (shown by 12). The blockchain stamp marketplace may then issue the membership digital stamps to the backers (shown by 13). As an example, an e-commerce store (which may be referred to as an “e-commerce global store,” “e-commerce network,” or “decentralized network collective of merchants”), such as the Combo Pay System described previously above, which may be globally accessible by various users, may be an online store for members of the reward management system and non-members alike (shown by 14). Merchants and retailers may pay small transaction sales referral fees to the e-commerce global store (shown by 15).

As an example, the sponsor may purchase the intellectual property (IP) of products or companies that are generating or will be generating revenue and sales and may place them in a holding group platform (shown by 16). These sponsor-purchased revenue assets may be added to the retailers and merchants accessible through the e-commerce global store (e.g., the Combo Pay System) (shown by 16A). As an example, a percentage of the revenue from the net collective of shoppers buying from the e-commerce global store may generate a royalty (shown by 17), such as the digital loyalty rewards described previously when referring to FIGS. 1A-1D, for example. Bonus points (which may be referred to as e-commerce bonus points) that are generated within the e-commerce global store may be deposited into a bank for members, which may be referred to as a depository bank for members (shown by 18). E-commerce bonus points may exist as funds, and such funds may be wired to the e-commerce depository bank for members (shown by 18A). The system for generation of bonus points from the e-commerce global site may be referred to as a revenue collective bonus points exchange. The exchange may issue membership digital stamps to a member's digital wallet (shown by 19), as an example.

As mentioned previously above, a user may also be a member of the e-commerce global store or the e-commerce network (e.g., the Combo Pay System). An e-commerce member may initiate a purchase request, in the manner shown by the flowchart of FIGS. 1A-1D, for example, for a product or service offered through the e-commerce network (shown by 20), as an example. In order to complete the purchase, the e-commerce member or backer may send their owned bonus point stamps to a digital stamp exchange to convert their stamps into currency, such as US dollars (shown by 21). Stamps that are converted into dollars may then be sent to the depository bank for members (shown by 21A). It should be understood that the depository bank may be selected as a payment type (e.g., for the payment vehicle, as used previously above) within a user's particular Combo Pay System account, for example. Bonus points that are generated by sales commission royalties may also be converted into currency such as US dollars, and this may also be sent to the e-commerce member bank and may be recorded to a specific member or user's bank holding account or depository bank (shown by 22), for example.

As an example, if a user does not have sufficient stamps (i.e., digital rewards) for covering the cost of a desired purchase, the user may send credit card funds to the system (shown by 22A) or may allot funds from other payment sources within the user's Combo Pay System account (such as those outlined in FIG. 1A, for example). Next, the merchant bank of the e-commerce global store may confirm that payment has been made and send instructions for shipment of merchandise or fulfillment of goods or services to the user (shown by 22B). Next, the items may be shipped, or other suitable fulfillment of the purchase may take place (shown by 22C), such that the purchased good are delivered to the user, for example. Profits that are generated by the e-commerce store may be used for the payment of income taxes or sales taxes where applicable, or any other applicable taxes or fees, such as to a government agency, as an example (shown by 23).

As an example, if a user requires/desires additional capital, they may sell their membership digital stamps through a stamp exchange, via the reward management system (shown by 24), which may host a stamp exchange marketplace. These membership digital stamps may belong to a specific user and may have been accumulated over a period of time and from a vast variety of merchants, such as rewards received from retail stores, restaurants, coffee shops, or airline miles, or discounted hotel stays, etc. The stamp exchange marketplace may allow for the selling and bidding on of digital stamps in an open market auction (shown by 26), for example. A new user may be guided within the stamp exchange marketplace on how to open a digital wallet, for example. The user may make a purchase of membership stamps, and next begin to earn bonus point digital stamps (shown by 26A) (each time a transaction is made using the Combo Pay System, for example). As shown in FIG. 3A, a user who sells their stamps within the stamp exchange marketplace may be sent payment by the stamp exchange marketplace (shown by 27). A user may also exchange their digital stamps for currency within the marketplace, for example. The currency (e.g., cash) earned by the selling of membership digital stamps, for example, may be stored in a specified account belonging to each user within the reward management system and/or Combo Pay System, which may, again, be used as selectable payment type for use as a Combo Pay Method, for example. Thus, an advantage is that unused and accumulated digital rewards, originating from a plurality of different merchants, may be easily and effectively traded or auctioned, for example, in exchange for other digital rewards or currency to be used in commerce.

Again, as previously discussed above, a user may purchase products and services via the e-commerce network (shown by 28), as shown in FIGS. 3B-3C. As shown in FIG. 3C, a user, who, again, may be a member of the e-commerce network (e.g., the Combo Pay System), may refer or influence another user to purchase products or services from the e-commerce store, and as a result, may receive a sales commission for the referral sale (shown by 29). The sales commission may be in the form of digital stamps, which, again, may be exchanged for currency or other funds and/or used for commerce, for example. Similarly, a user, who, again, may be a member of the e-commerce network, may refer or influence another user to purchase digital stamps from the stamp exchange marketplace, and as a result, may receive a sales commission for the referral sale (shown by 29A), as shown in FIGS. 3A-3B, effectively establishing a referral program within the rewards management system.

Newly referred users who became members of the e-commerce network may purchase goods and services from the e-commerce store, and membership digital stamps from the stamp exchange marketplace, for example, and may then begin to receive membership benefits, as existing members already do (shown by 30), as shown in FIG. 3C. The stamp exchange marketplace may also instruct new members on how to obtain a digital wallet, which may be used to receive and store their digital stamps (shown by 31 in FIG. 3A). Next, after the newly referred member completes a purchase or transaction, for example, the referring member may receive sales commissions, which, again, may be in the form of digital stamps (shown by 32 in FIG. 3A).

As an example, an annual membership fee may be required or optional for users for membership to the e-commerce network (Combo Pay System, for example), which may give additional benefits to members (shown by 33 in FIG. 3B). Members of the e-commerce network may also receive other benefits. For example, a member could receive bonus rewards points when other members (e.g., referred members, new members) shop within the e-commerce network. As another example of a benefit, a user may be able to use a discount when redeeming goods or services using digital stamps. For example, the discount could be 20%, and thus, a user may be capable of purchasing an item valued at $100 for $80 when using their digital stamps. A user may also be capable of purchasing an item at a net zero cost if they have accrued sufficient digital stamps to cover the cost of an item or service offered in the e-commerce network. As another example, as was similarly discussed above when referring to FIGS. 1A-1D, a user may also be awarded additional bonus reward points as a reward currency when shopping in the e-commerce network. Thus, a user who has accumulated sufficient digital rewards points may be capable of shopping via the points and/or selling their points for currency. Thus, an advantage is that, because a wide variety of merchants may accept the digital rewards within the e-commerce network, the digital rewards themselves may function as a single currency.

As an example, a user may purchase high-value (i.e., expensive) items with a loan approval from a third party, as similarly described previously above when referring to FIGS. 1A-1D, which may be conducted via the reward management system (shown by 34 in FIG. 3B). Loan funds from the third party may be digitally and instantly uploaded to the user's account (e.g., depository account), which may then be used within the e-commerce network in order to pay for a user's high-value purchase (shown by 35 in FIG. 3B). As described previously, the loans may be gradually repaid in installments or the loans may be automatically deducted from the user's account when new digital rewards points are earned (i.e., a cash equivalent of the digital rewards points may be used to pay off a portion or all of the loan).

The reward management system shown and described herein may thus add value to consumers' purchases by the generation of bonus points and rewards points and may also be advantageous for users by diminishing or eliminating the need for tracking multiple rewards programs (shown by 36 in FIG. 3B) received by various different merchants and retailers, as an example. It should be understood, as outlined above, the reward management system disclosed herein may work with the Combo Pay System of FIGS. 1A-1D for managing the digital loyalty rewards portion of the Combo Pay System or may selectively work separately from the Combo Pay System and alternatively with an existing e-commerce network, for example.

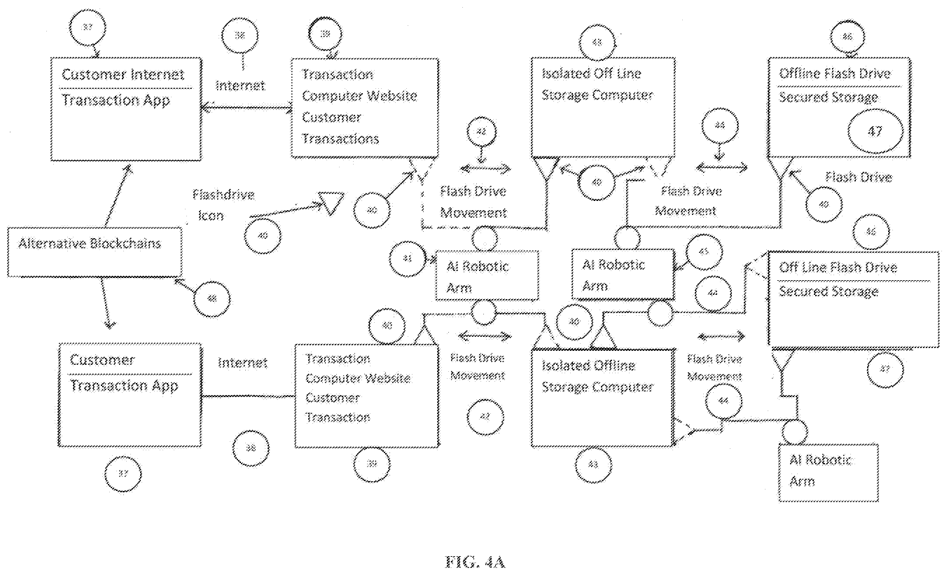

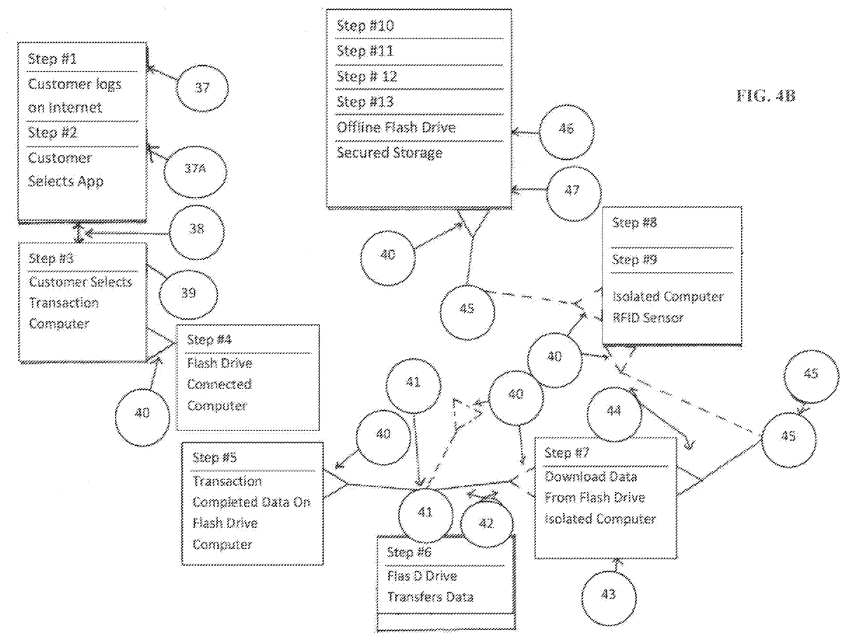

FIGS. 4A-4B illustrate examples of a diagrammatic view of isolated data storage working with autonomous robotic offline data storage, according to an aspect. As shown as an example, a system for isolated security data storage (“isolated security data storage,” “isolated data storage system,” “isolated data storage,” “isolated security data storage and autonomous robotic offline data storage,”) may be used with the Combo Pay System and the reward management system shown and described when referring to FIGS. 1A-1D and FIGS. 3A-3C, respectively. Particularly, the isolated data storage system may be used for any suitable commerce, transaction, or information relaying performed or carried out online within the above-mentioned systems, for example. The isolated data storage system, to be described below, may thus enhance the security of users' information when using, navigating, and carrying out transactions within the reward management system and the Combo Pay System (or other e-commerce network, for example), such as the information shown and described previously when referring to FIGS. 3A-3C.

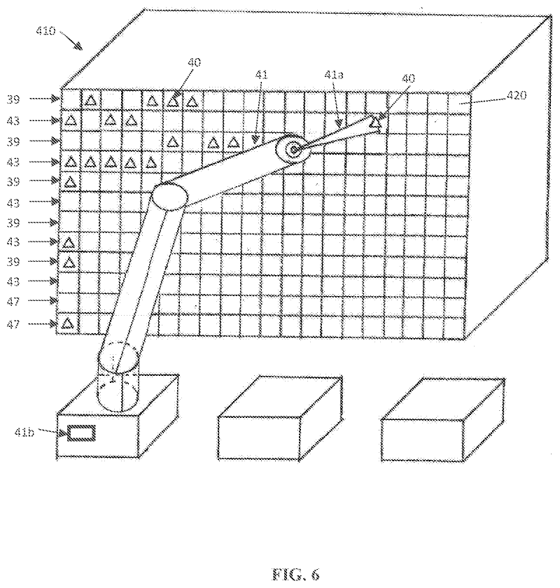

As an example, two alternative blockchains (shown by 48) representing two separate transactions are shown by FIG. 4A. In each, a user, who may be a customer/consumer, may first make an online connection to an e-commerce store (e.g., the Combo Pay System) via their mobile device, computer, or any other suitable electronic device. The online connection may be made via a mobile application (e.g., the Combo Pay app) operating on the electronic device (shown by 37). The user may be connected to the e-commerce store via an internet connection (shown by 38), for example. Next, the user may make selections within the application and provide product selection information and payment information (which may be referred to as transaction data). The transaction data may not be downloaded to the non-volatile data storage devices of the e-commerce store's computers or mainframe computer, which may be hard drives, for example. The transaction data may similarly not be uploaded into a cloud storage operating on the internet (shown by 39). Rather, the transaction data may be downloaded to a memory storage device, such as a USB flash drive (shown by 40), which may physically be removed and moved to (shown by 42) an isolated computer (“isolated computer,” “offline computer,” “isolated storage computer,” “isolated storage”) kept in an undisclosed location, thus moving the transaction data offline (shown by 43). An autonomous robotic gripper arm (“autonomous robotic arm,” or “robotic arm”) (shown by 41; see also FIG. 6) may be used for the removal and moving of the flash drive 40. As an example (see FIG. 6), the autonomous robotic arm 41 may be provided with a pre-programmed microcontroller 41b or microprocessor or the like, for example, such that to control the autonomous movements of the robotic arm 41 and its claws or tongs 41a that can be used to grab flash drive 40. Once the flash drive 40 is moved to the isolated storage computer(s) (shown by 43), the transaction data can be stored on the isolated storage computer via the flash drive 40. The information carried by the flash drive may also be stored in an offline, secured identifier capsule, which may have an RFID or any other suitable electronic tag locator or make use of any other suitable locator system, such that the robotic arm 41 may be able to locate any particular flash drive related to a specific user's cryptic, secure code ID.

Again, as previously discussed, the robotic arm 41 may autonomously remove the flash drive 40 from an offline computer (shown by 43) to offline secured storage (shown by 46 and 47), as shown in FIGS. 4A-4B. It should be noted that, after user data has been downloaded to the offline computer, the user data may or may not be digitally erased from the flash drive(s). For example, it may be advantageous to erase user data from the flash drives after the downloading of the user data onto the offline computer, such that to free up storage space within the flash drive for storing future user data. As an example, the offline secured storage 47 may be secured storage racks, which may comprise a plurality of capsules having a receiving means for receiving the flash drives (e.g., USB ports) and an automated door (e.g., retractable door, sliding door) capable of autonomously opening and closing, such that to allow the robotic arm access to the capsules, for example. As an example, electronic tag (e-tag) locators may be used, as mentioned above, for assisting the robotic arm 41 in locating each capsule, while also monitoring which user's data is associated with which flash drive, and thus the capsule that the particular flash drive is stored in, for example. Additional robotic arms (shown by 45) may also be used as needed for the movements of the various users' flash drives. Thus, as outlined above, because user data is physically stored in flash drives housed within the plurality of capsules in the offline computer located in an undisclosed location, the user data may be maximally secured, such that to prevent hackers and other unauthorized individuals from accessing the user data.

It should be understood that each user may be provided with a flash drive and a corresponding storage capsule for the secure and isolated storing of transaction data in the offline computer (or other electronic hardware), for example. It should be noted that each user may be provided with a plurality of flash drives, for example, to meet the storage capability requirements for users having large transaction data histories. It should also be understood that the memory storage device may be other suitable removable storage devices other than a flash drive, such as a Compact Disks (CDs), Solid-State Drives (SSDs), SD cards, micro-SD cards, floppy disks, etc. It should also be understood that the offline computer may be and include any electronic storage hardware that is not connected to the internet and being adapted to receive the memory storage devices.

As shown as an example, the offline secured storage area comprising a set of secure storage racks for physical storage of flash drives (shown by 46) may have clean storage capsules which, again, may be provided with electronic locator tags or RFID tags, or, again, any other suitable locator system. As an example, the steps shown and described when referring to FIGS. 4A-4B may also be performed in reverse, such that a flash drive may be used for collecting data (e.g., transaction data) from a user's subsequent purchases and then uploading said data into the e-commerce network (e.g., the Combo Pay System). As will be described in detail below, the various user data being transmitted or relayed within the e-commerce network and the rewards management system may be highly secured using blockchain technology, before being stored within the isolated data storage system described above. The isolated data storage system may be used for a transaction (or other action involving user data) by carrying out the following exemplary blockchain process.

FIGS. 5A-5C illustrate examples of a diagrammatic view of a blockchain network using blockchains in a juxtaposed formation and an amalgamated formation, according to an aspect. A blockchain network, as is known in the art, may be used for the relaying of information within an e-commerce network (e.g., the Combo Pay System) and the reward management system, for example. Again, as previously discussed, a blockchain may be a continuously growing list of records known as blocks, which may be linked and secured using cryptography, as is known in the art. Each block may typically contain a high pointer as a link to a previous block, a timestamp, and transaction data, as is known in the art. As an example, each step in the process of carrying out a transaction in the e-commerce store as shown and described herein, may have its own blockchain of records of data, which may include timestamps and transaction data. Each blockchain may be capable of processing more than one million transactions per second, for example. Again, as was previously discussed above, and as is known in the art, blockchains may be inherently resistant to modification of data. Thus, an advantage may be that security may be enhanced for the users of the e-commerce network and the reward management system.

As shown in FIG. 5A, juxtaposed blockchains (shown by 48) may be used to target separate transactions and may help to increase security and anonymity of the users of the e-commerce network and reward management system. Juxtaposed blockchains may process related data (e.g., usernames and passcodes) separately, such that to provide increased data protection from hackers. This data may be data such as the transaction data generated during transactions (shown by 48, 57, and 66) until the data is sent to become amalgamated (shown by 49, 58, and 67). The amalgamated data may be referred to as a “super blockchain” (shown by 50, 50A, 59, 59A, 68, and 68A in FIGS. 5A-5C), for example. This amalgamation may be performed via a Wi-Fi connection, for example, from the juxtaposed blockchain computer system into the super blockchain computer system. Within the super blockchain, the data may be carrying more than one million transactions a second, for example. As represented by 50A in FIG. 5A as an example, data blocks of information in the super blockchain may include information such as the number of digital rewards being issued by a certain crowdfunding campaign, the number of backers contributing a particular amount of funds, or the physical origin of funds, and the location (e.g., geographical location) of the highest number of backers. It should be understood that these examples and any other suitable examples of information that may be transmitted or relayed could also be relayed in other steps or aspects of the e-commerce network, such as the Combo Pay System, and the reward management system. Next, the amalgamated data can once again become juxtaposed when it is outputted, which again could be through a Wi-Fi connection, and which could be outputted back to the originator of the data, or to any other suitable requester of the data (shown by 56, 65, and 74 in FIGS. 5A-5C), for example. It should also be understood that the transaction data or any other suitable data that is outputted may be stored offline in an isolated data storage system, as shown in FIGS. 4A-4B and described previously above.

FIG. 5A shows that the data relayed from the process shown and described by 1-13 of FIGS. 3A-3C may be transmitted and secured by using a juxtaposed and amalgamated blockchain formation, for example. FIG. 5B shows that the data relayed from the process shown and described by 14-25 of FIGS. 3A-3C may be transmitted and secured by using a juxtaposed and amalgamated blockchain formation, for example. FIG. 5C shows that the data relayed from the process shown and described by 26-36 of FIGS. 3A-3C may be transmitted and secured by using a juxtaposed and amalgamated blockchain formation, for example. Data that may be secured and transmitted using the juxtaposed and amalgamated blockchain formation shown as examples in FIGS. 5A-5C may include data related to events, e-commerce, inventory control, shipping, medical records, medical treatment, management activities, customer identity management, transaction processing, documenting provenance, food traceability, rewards tracking, and rewards redemption. Thus, as outlined above, user data may be securely and effectively transmitted within and/or between the e-commerce network and the universal rewards system before being digitally downloaded and stored in isolated data storage, for example, as described previously when referring to FIGS. 4A-4B.

FIG. 6 illustrates an example of a diagrammatic view of secured isolated data storage system working with an autonomous robotic arm, according to an aspect. As shown, a computer and storage rack system 410 may be provided, having stacked rows of slots 420. A robotic arm having tongs 41a and being controlled by a microprocessor 41b, may also be provided. The location of each slot 420 may be designated by a unique identifier (e.g., a QR code), which the robotic arm could read (e.g., via a QR code reader, not shown) and the location data may be used by the microprocessor 41b to direct the robotic arm 41 and its tongs 41a to the right location.

As shown in FIG. 6, rows designated for the online transaction computers 39 may be placed adjacent to offline storage computers 43. That way, once an online transaction is completed, the robotic arm 41 can simply grab the respective flash drive 40, remove it from the respective online transaction computer 39 and place it in the appropriate port of the offline storage computer 43, on the row immediately below. It should be noted that rows of storage capsules 47 can also be provided in the rack system 410. As described, the flash drives 40 can be moved also from an offline storage computers 43 to a storage capsule 47. Alternatively, a flash drive 40 can be moved directly from an online transaction computer 39 to a storage capsule 47, for example when the data is kept exclusively on the flash drive 40 and thus there is no need to download it into an offline storage computer 43.

It should be understood that each slot 420 of rack 410 will host an online transaction computer 39 on the respective row. Similarly, each slot 420 of rack 410 will host an offline storage computer 43 on the respective row. Lastly, each slot 420 of rack 410 will host a storage capsule 47 on the respective row.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A global combination payment system for use in commerce by users, the global combination payment system comprising:
a combination payment platform configured to operate on a device, the combination payment platform being adapted to provide users with an interface through which the users may interact with other users, such that to engage in commerce, make payments, and exchange goods and services; and
a combination payment vehicle for use as a payment method within the combination payment platform, the combination payment vehicle comprising a plurality of distinct and separate funding sources that may be selectively combined to make a purchase, the plurality of funding sources being selectable from cash, credit card, debit card, payday loan, cryptocurrency holdings, merchant digital loyalty rewards, and investment stock and bond holdings;
wherein a total value of the plurality of funding sources defines a line of credit via which to make a payment;
wherein the users each have a user account within the combination payment platform for engaging in commerce with other users; and
wherein, when a first user makes a purchase from a second user via the combination payment platform, a cost of the purchase is deducted from the total value of the plurality of funding sources, such that each of a selected portion of the cost of the purchase is deducted from a value of each selected funding source of the plurality of funding sources, respectively.

2. The global combination payment system of claim 1, wherein the device is a payment card.

3. The global combination payment system of claim 1, wherein the combination payment platform is a mobile application configured to operate on the device.

4. The global combination payment system of claim 1, wherein the plurality of funding sources is further selectable from private and institutional lender loans, investment commodity holdings, real estate holdings, and personal belongings.

5. The global combination payment system of claim 7, wherein a cash value of each of the personal belongings contributes to the total value of the plurality of funding sources.

6. The global combination payment system of claim 1, wherein the first user is a consumer, and the second user is a merchant.

7. The global combination payment system of claim 1, wherein user data collected by and exchanged within the global combination payment system is amalgamated and secured using blockchain technology.

8. The global combination payment system of claim 1, wherein user data collected by and exchanged within the global combination payment system is stored within an isolated data storage system, the isolated data storage system comprising:
a plurality of memory storage devices each configured to store user data of each user on the combination payment platform, respectively;
an offline computer configured to receive each of the plurality of memory storage devices, such that the user data stored on the plurality of memory storage devices can be digitally transferred to the offline computer; and
a robotic arm adapted to autonomously move each of the plurality of memory storage devices from the offline computer to a set of storage racks having a plurality of capsules, each of the plurality of capsules being adapted to house each of the plurality of memory storage devices for safe storage of the user data.

9. A global combination payment system for use in commerce by users, the global combination payment system comprising:
a combination payment platform configured to operate on a device, the combination payment platform being adapted to provide users with an interface through which the users may interact with other users, such that to engage in commerce, make payments, and exchange goods and services; and
a combination payment vehicle for use as a payment method within the combination payment platform, the combination payment vehicle comprising a plurality of distinct and separate funding sources that may be selectively combined to make a purchase, the plurality of funding sources being selectable from cash, credit card, debit card, payday loan, cryptocurrency holdings, merchant digital loyalty rewards, and investment stock and bond holdings;
wherein the plurality of funding sources are automatically assigned a priority ranking based on a value of each of the plurality of funding sources, a funding source having a highest value being ranked first and a funding source having a lowest value being ranked last; and
wherein a total value of the plurality of funding sources defines a line of credit via which to make a payment.

10. The global combination payment system of claim 12, wherein, when a first user makes a purchase from a second user via the combination payment platform, a cost of the purchase is deducted from the total value of the plurality of funding sources, such that at least a portion of the cost of the purchase is deducted from the value of the first ranked funding source of the plurality of funding sources, and any remaining portion of the cost is deducted from a value of a second ranked funding source of the plurality of funding sources.

11. The global combination payment system of claim 12, further comprising an isolated data storage system being in communication with the combination payment platform, the isolated data storage system comprising:
a plurality of memory storage devices each configured to store user data of each user on the combination payment platform, respectively;
an offline computer configured to receive each of the plurality of memory storage devices, such that the user data stored on the plurality of memory storage devices can be digitally transferred to the offline computer; and
a robotic arm adapted to autonomously move each of the plurality of memory storage devices from the offline computer to a set of storage racks having a plurality of capsules, each of the plurality of capsules being adapted to house each of the plurality of memory storage devices for safe storage of the user data.

12. The global combination payment system of claim 13, wherein the first user is a consumer and the second user is a merchant.

13. The global combination payment system of claim 12, wherein the device is a payment card.

14. The global combination payment system of claim 12, wherein the combination payment platform is a mobile application configured to operate on the device.

15. The global combination payment system of claim 12, wherein the plurality of funding sources is further selectable from private and institutional lender loans, investment commodity holdings, real estate holdings, and personal belongings.

16. The global combination payment system of claim 21, wherein a cash value of each of the personal belongings contributes to the total value of the plurality of funding sources.

17. A method of making a purchase using a global combination payment system, the global combination payment system comprising a combination payment platform configured to operate on a device, the combination payment platform being adapted to provide users with an interface through which the users may interact with other users, and a combination payment vehicle for use as a payment method within the combination payment platform, the combination payment vehicle comprising a plurality of distinct and separate funding sources that may be selectively combined to make a purchase, the method comprising the steps of:
creating and/or logging into a user account within the combination payment platform via the device;
selecting and linking a plurality of funding sources with the user account, such that to form the combination payment platform, a total value of the plurality of funding sources defining a line of credit via which to make a payment;
selecting a merchant from whom to purchase goods and/or services from, the merchant being a user within the global combination payment system;
selecting goods and/or services to purchase from the merchant, the selection of, and a total cost of, the goods and/or services being virtually collocated within a shopping cart of the combination payment platform; and
purchasing the selected goods and/or services from the shopping cart, the total cost of the goods and/or services being deducted from the total value of the plurality of funding sources, such that each of a selected portion of the total cost of the purchase is deducted from a value of each selected funding source of the plurality of funding sources, respectively.

18. The method of claim 23, wherein the plurality of funding sources are selectable from cash, credit card, debit card, payday loan, cryptocurrency holdings, merchant digital loyalty rewards, and investment stock and bond holdings, private and institutional lender loans, investment commodity holdings, real estate holdings, and personal belongings each belonging to the user.

19. The method of claim 24, further comprising:
receiving digital loyalty rewards from the merchant, the digital loyalty rewards being added to the merchant digital loyalty rewards funding source;
receiving the goods and/or services purchased from the merchant;
if the goods and/or services are satisfactory, confirming satisfaction with the goods and/or services received from the merchant on the combination payment platform;
if the goods are back-ordered, receiving additional digital loyalty rewards from the merchant, the additional digital loyalty rewards being added to the merchant digital loyalty rewards funding source; and
if the goods and/or services are unsatisfactory:
confirming nonsatisfaction with the goods and/or services received from the merchant on the combination payment platform; and
receiving a refund of the total cost of the goods and/or services purchased from the merchant, the refund being added to the total value of the plurality of funding sources.

20. The method of claim 23, wherein the combination payment platform is a mobile application configured to operate on the device.

21. The method of claim 23, wherein the selecting a merchant from whom to purchase goods and/or services from is performed by:
searching for a merchant via a search engine within the combination payment platform, the search engine being configured to receive, and thus display search results according to, user-selected preferences, the user-selected preferences being selectable from at least one of a country of origin, types of goods and services, price range, and proximity to user; and
selecting a merchant from the search results of the search engine being displayed on the device, the selecting of a merchant subsequently causing a displaying of the goods and services offered by the merchant.

22. The method of claim 23, wherein the purchasing the selected goods and/or services from the shopping cart is performed by:
selecting a shipping method by which to receive the selected goods and/or services;
pressing a digital purchase button in the shopping cart, the pressing of the digital purchase button authorizing purchase of the selected goods and/or services; and
choosing how to use the plurality of funding sources as a payment method by doing one of:
selecting an automated payment option, the automated payment option causing an identifying of a funding source of the plurality of funding sources having a value equal to or above the total cost of the purchase, the total cost of the purchase subsequently being deducted from the value of the funding source; and
manually selecting funding sources of the plurality of funding sources and a portion of the total cost of the purchase from which to deduct from each of the funding sources, the portion of the total cost of the purchase subsequently being deducted from a value of each of the manually selected funding sources.

23. A method of making a sale using a global combination payment system, the global combination payment system comprising a combination payment platform configured to operate on a device, the combination payment platform being adapted to provide users with an interface through which the users may interact with other users, and a combination payment vehicle for use as a payment method within the combination payment platform, the combination payment vehicle comprising a plurality of distinct and separate funding sources that may be selectively combined to make a purchase, the method comprising the steps of:
creating and/or logging into a user account within the combination payment platform via the device;
selecting and linking a plurality of funding sources with the user account, such that to form the combination payment platform, each of the plurality of funding sources being adapted to receive funds processed by the global combination payment system;
listing goods and/or services available for purchase by a consumer, the consumer being a user within the global combination payment system;
assigning a price to each of the listed goods and/or services for purchase by a consumer;
providing a plurality of shipping methods by which to ship purchased goods to a consumer; and
when a consumer purchases one or more of the listed goods and/or services, receiving a total price of the goods and/or services purchased, the total price being added to a total value of the plurality of funding sources, such that each of a selected portion of the total price of the purchase is added to a value of each corresponding funding source of the plurality of funding sources, respectively.

24. The method of claim 32, wherein the plurality of funding sources are selectable from cash, credit card, debit card, payday loan, cryptocurrency holdings, merchant digital loyalty rewards, investment stock and bond holdings, private and institutional lender loans, investment commodity holdings, real estate holdings, and personal belongings each belonging to the user.

25. The method of claim 33, further comprising:
shipping the goods purchased by the consumer according to the consumer-selected shipping method;
if the goods and/or services are indicated as being satisfactory by the consumer, receiving the total price of the goods and/or services purchased, the total price being added to the total value of the plurality of funding sources, such that each of a selected portion of the total price of the purchase is added to a value of each corresponding funding source of the plurality of funding sources, respectively;
if the goods and/or services are indicated as being unsatisfactory by the consumer, issuing a refund of the total price of the goods and/or services purchased to the consumer, such that the total price of the goods and/or services being refunded are deducted from the total value of the plurality of funding sources; and
if the goods are back-ordered, shipping the goods purchased by the consumer once the goods are no longer back-ordered.

26. The method of claim 32, wherein the combination payment platform is a mobile application configured to operate on the device.

27. The method of claim 32, wherein the listing goods and/or services available for purchase by a consumer is performed by listing the goods and/or services available for purchase by a consumer, including details regarding country of origin, types of goods and services offered, price range, and shipping location, such that to enable a consumer to search via a search engine within the combination payment platform according to selectable preferences.

28. A method of facilitating a global combination payment system for use in commerce by users, the method comprising the steps of:
providing a combination payment platform configured to operate on a device and to provide users with an interface through which the users may interact with other users, the combination payment platform being programmed to:
establish a relationship between a user and the combination payment platform via a user account, the user account providing the user with a central hub via which to selectively engage in commerce, make payments, exchange goods and services, and track shipments;
digitally establish a connection with, and securely link, the user's account with a plurality of distinct and separate funding sources, such that to form a combination payment vehicle for use as a payment method within the combination payment platform, the plurality of funding sources being adapted to be selectively combined such that to make a purchase, and the plurality of funding sources being selectable from cash, credit card, debit card, payday loan, cryptocurrency holdings, merchant digital loyalty rewards, and investment stock and bond holdings; and
digitally store user data into a memory storage device, the memory storage device being configured to be autonomously moved to an offline computer, such that to digitally transfer the user data into the offline computer for safe storage of the user data.

29. The method of claim 40, wherein the combination payment platform is further programmed to:
filter search results according to user-preferences input into a search engine of the combination payment platform, the user-selected preferences being selectable from at least one of a country of origin, types of goods and services, price range, and proximity to user;
display goods and/or services being offered for purchase by various merchant users via a screen on the device; and
facilitate purchasing of user-selected goods and/or services from a merchant user by calculating a total cost of the user-selected goods and/or services, including applicable tax and shipping costs, and deducting the total cost from a total value of the plurality of funding sources, such that each of a selected portion of the total cost is deducted from a value of each selected funding source of the plurality of funding sources, respectively.

30. The method of claim 40, wherein access to the user account requires a receiving of a username and personal password or passcode, the user account allowing secure access to any information related to the user, the information being transaction data, payment history, purchase history, and funding sources.

31. The method of claim 40, wherein the memory storage device is configured to be autonomously moved to the offline computer via an autonomous robotic arm.

32. The method of claim 40, wherein the combination payment platform is a mobile application configured to operate on the device.

33. An isolated data storage system for the safe and secure storage of user data being transmitted within a network, the isolated data storage system comprising:
a plurality of memory storage devices each being removably associated with at least one mainframe computer in communication with the network, each memory storage device being configured to digitally receive user data from the at least one mainframe computer;
at least one robotic arm configured to autonomously move each memory storage device of the plurality of memory storage devices;
at least one offline computer being adapted to receive the plurality of memory storage devices, such that the user data stored on each of the plurality of memory storage devices may be downloaded to the at least one offline computer; and
a set of storage racks having a plurality of capsules, each capsule of the plurality of capsules being adapted to receive each of the plurality of memory storage devices, respectively, such that to securely store the plurality of memory storage devices;
wherein, when user data is received by a memory storage device of the plurality of memory storage devices, one of the at least one robotic arm autonomously removes the memory storage device from the at least one mainframe computer and associates the memory storage device with one of the at least one offline computer, the user data being digitally transferred from the memory storage device into the offline computer, the one of the at least one robotic arm subsequently and autonomously moving the memory storage device from the one of the at least one offline computer to the set of storage racks, the memory storage device being placed into a capsule of the plurality of capsules.

34. The isolated data storage system of claim 48, wherein the global e-commerce network is a global combination payment system comprising a combination payment platform configured to operate on a device, the combination payment platform being adapted to provide users with an interface through which the users may interact with other users, and a combination payment vehicle for use as a payment method within the combination payment platform, the combination payment vehicle comprising a plurality of distinct and separate funding sources that may be selectively combined to make a purchase.

35. The isolated data storage system of claim 46, wherein the plurality of capsules each comprises:
an electronic tag (e-tag) for providing each capsule with an identifier means, such that to aid the at least one robotic arm in locating a memory storage device associated with a particular user; and
a door adapted to be autonomously opened and closed, such that to allow the at least one robotic arm access to the capsule.

36. The isolated data storage system of claim 50, wherein the at least one robotic arm is further configured to:
digitally read the e-tag of each of the plurality of capsules, such that to locate a particular capsule for associating a memory storage device with the particular capsule, and such that to monitor user data associated with the memory storage device; and
autonomously place the memory storage device into the particular capsule when the door is being autonomously opened.

37. A method of facilitating a universal rewards program for use in managing digital rewards received by users from a global e-commerce network, the method comprising the steps of:
providing a rewards management system configured to operate on a device and to provide users with an interface through which the users may interact with other users, the rewards management system being programmed to:
establish a relationship between a user and the rewards management system via a user account, the user account being digitally linked to the global e-commerce network and providing the user with a central hub via which to selectively monitor, purchase, or sell the digital rewards;
digitally establish a connection with, and securely link, the user's account with at least one depository account for use as a supplemental payment method, the at least one depository account being adapted to supply or receive funds;
store the digital rewards and any additional digital rewards in a digital wallet associated with the user account;
selectively convert digital rewards stored within the digital wallet into currency to be deposited into the at least one depository account, or exchange the digital rewards for other digital rewards stored within a second digital wallet belonging to a second user; and
digitally store user data into a memory storage device, the memory storage device being configured to be autonomously moved to an offline computer, such that to digitally transfer the user data into the offline computer for safe storage of the user data.

38. The method of claim 49, wherein the rewards management system is further programmed to:
facilitate purchasing of user-selected goods and/or services from a merchant user within the e-commerce network by calculating a total cost of the user-selected goods and/or services, including applicable tax and shipping costs, and deducting the total cost from a total value of the digital rewards stored within the digital wallet, and any remaining portion of the total cost being deducted from a total value of the funds of the at least one depository account; and
deposit new digital rewards earned from the purchasing of the user-selected goods and/or services into the digital wallet.

39. The method of claim 49, wherein the digital rewards are at least one of: digital points, digital stamps, rewards points, digital loyalty rewards points, tokens, goods, and services.

40. The method of claim 49, wherein the global e-commerce network is a global combination payment system comprising a combination payment platform configured to operate on a device, the combination payment platform being adapted to provide users with an interface through which the users may interact with other users, and a combination payment vehicle for use as a payment method within the combination payment platform, the combination payment vehicle comprising a plurality of distinct and separate funding sources that may be selectively combined to make a purchase.

41. The method of claim 49, wherein users are issued digital rewards for financially contributing to a publicized crowdfunding campaign within the global e-commerce network.

42. The method of claim 52, wherein users are issued digital rewards for engaging in commerce within the global combination payment system, wherein the digital rewards are digital loyalty rewards issued to consumer users and merchant users for purchasing goods and/or services from other merchant users.

43. The method of claim 49, wherein the memory storage device is configured to be autonomously moved to the offline, mainframe computer via an autonomous robotic arm.

44. The method of claim 49, wherein user data collected by and exchanged within the reward management system is transmitted and secured using a juxtaposed and amalgamated blockchain formation.
